(19) United States
(12) Patent Application Publication
(10) Pub. No.: US 2018/0006492 A1
(43) Pub. Date: Jan. 4, 2018

(54) ENERGY MANAGEMENT SYSTEM AND CONTROL METHOD THEREFOR

(71) Applicant: Young-Bum KIM, Gwacheon-si, Gyeonggi-do (KR)

(72) Inventors: Young-Bum KIM, Gwacheon-si (KR); Chang-Ho KIM, Gwacheon-si (KR)

(21) Appl. No.: 15/541,371

(22) PCT Filed: Jan. 11, 2016
(86) PCT No.: PCT/KR2016/000243

§ 371 Date: Jul. 1, 2017

(30) Foreign Application Priority Data
Jan. 9, 2015 (KR) 10-2015-0003210
Jan. 20, 2015 (KR) 10-2015-0009076
Mar. 2, 2015 (KR) 10-2015-0028858

(51) Int. Cl. H02J 13/00; G05B 19/042

(52) U.S. Cl. CPC H02J 13/0017; G05B 19/042; G05B 2219/2642

(57) ABSTRACT

An energy management system of the present invention can measure and integrate a power consumption amount of each device, can integrate and monitor regional total power consumption amounts, and allows energy to be effectively used by collecting, analyzing, storing and transmitting a use pattern and data through the Internet of Things (IoT) between devices and completely and automatically cutting off and controlling the power to be wasted in a device when the device is not used. The energy management system remotely controls devices and allows energy to be effectively managed through the minimization of power consumption by automatically and completely cutting off the power to be supplied to the devices when the devices are not used, and by cutting off the power to be supplied to the system when the power of all the devices connected to the system is cut off and when the system is in standby.

### CROSS-REFERENCE TO RELATED APPLICATIONS

This patent application is a national-stage application of PCT/KR2016/000243 filed on Jan. 11, 2016 which claims priority under 35 U.S.C. §119 to Korean Patent Application Nos. 10-2015-003210, 10-2015-0009076, and 10-2015-0028858, respectively filed on Jan. 9, 2015, Jan. 20, 2015, and Mar. 2, 2015, in the Korean Intellectual Property Office, the disclosures of which are incorporated by reference herein in their entireties.

### TECHNICAL FIELD

The present invention relates to a smart home/building energy management system for efficient use of energy in, e.g., houses (smart homes), offices, buildings, and factories.

### DISCUSSION OF RELATED ART

As the convergence of electronic devices leads to a tendency of increasing Internet of Things (IoT) devices, energy consumption is expected to sharply grow. Due to such expectation, the International Energy Agency (IEA) recommends the development of low-power electronic devices that consume less power.

Conventional energy management systems are in the form of accruing and showing per-household power consumption to the customer or analyzing a use pattern per electronic device and inducing customers to change their life pattern.

Such a system exhibits a limitation in reducing energy consumption because energy management components of the system consume other power. The system also suffers from the problem that it cannot cut off the power of existing electronic devices.

Existing techniques for energy management system include, e.g., smart meters, power measuring AC receptacles, remote control AC receptacles, smart multi-outlet adapters (smart power strips), smart home systems, or wide area campus energy managing systems through the control or monitoring of network.

The smart meter, which is a power meter for home use, has a communication sub system that immediately or monthly provides power usage to a utility facility for the purpose of billing and power supplying plan and creates dynamic, bi-lateral conversations between utility facilities and the customer. Such conversations target raising energy efficiency and grasping demand reactions. Tendril is a commercially available example of such. Power consumption is the accrued sum per household.

Generally, the power measuring AC receptacles is a sort of auxiliary device that is inserted between a normal AC receptacle and a device (each electronic product) connected to the normal AC consent and measures power applied from the normal AC receptacle and the device. A result of the measurement is generally shown on a display connected with the device. The result allows the user to be aware how much power a particular product consumes in what operation mode. For easier energy savings, the user may determine a use plan a commercially available example of which is ‘Kill-A-Watt.’

The remote-control AC receptacle is generally a kind of auxiliary device inserted between a normal AC receptacle and a device. The remote-control AC receptacle typically includes a switch for turning on or off a main power source of the device. Such device may be remotely controlled by various techniques, such as those using infrared rays, radio frequency (RF) waves, or power line signals. Some techniques using modems, routers, or the Internet enable control at a site that is further away from the premises where devices and equipment are installed. The device may remotely control the usage of device, enabling an enhancement of energy usage rate, a commercially available example of which is ‘Wayne Dalton.’

The smart multi-outlet adapter, a branch of AC receptacles, is typically divided into two types, i.e., a master and a peripheral. The power consumption at the master plug slot is monitored. Where a device connected to the master plug slot consumes power (standby power) not more than a threshold, power is automatically cut off to further reduce power consumption at the peripheral plug slot, thereby turning off the peripheral. In contrast, where a higher level of power (normally reactivated) than the threshold is consumed at the master plug slot, power is automatically supplied to the peripheral plug slot, turning on the peripheral. For example, when a computer is connected to the master plug slot, a relevant monitor, printer, router, or speaker is connected to the peripheral plug slot. Examples commercially available are ‘IntelliPanel’ and ‘BuLogics.’

The smart home system is generally a wide area home network that collects various devices, such as lamp switches, AC receptacles, door locks, indoor temperature controllers, or remote controllers. The devices communicate with one another to form a network and may use RF waves, infrared rays, or power lines, as a networking medium. Such system is called home control automation. Although some devices come up with power measuring functionality, there are generally no proactive, energy saving schemes for allowing the user to save energy. ‘HAI,’ ‘EnergyHub,’ and ‘Energate’ are among examples commercially available.

The wide area campus energy managing system connect various sub systems, e.g., power measuring AC receptacles and remote-control AC receptacles, using a network infrastructure. The wide area campus energy managing system is generally divided into small-area clusters for installation on an overall campus and easier maintenance. The control center assesses energy usage and then controls devices of control individually or per cluster to enhance power consumption. Examples commercially available are ‘Cisco's Energy Wise’ and ‘Agile waves.’

However, the above-mentioned energy management devices or systems have their own shortcomings. For example, the smart meter reports only the total power usage per household but does not how an individual piece of equipment consumes power, rendering energy management difficult or inefficient.

The power measuring AC receptacle, although letting it known how much power a device consumes, is of no proactive help to the user in light of energy savings.

Likewise, the remote-control AC receptacle requires the user's involvement upon switching off to save energy. By contrast, the smart multi-outlet adapter provides an active support for the user to save energy, and the smart multi-outlet adapter, after measuring the master device, automatically switches off peripheral devices. The only shortcoming is that the master and the peripherals should be connected to the same smart multi-outlet adapter.

The wide area campus energy management system is a most perfect automation solution. However, the energy saving effect for home users is overwhelmed by the complexity in implementation, cost of equipment, and maintenance work.

A more serious situation is that additional energy consumption arises from devices that adopt the above-mentioned techniques introduced for efficient energy management to minimize power consumption

The application of the above techniques requires introduction of remote control AC receptacles, smart multi-outlet adapters, or energy management systems, as new devices. Although powering off a device connected with such device (e.g., an AC receptacle or smart multi-outlet adapter), the power consumption of the device itself keeps occurring. Thus, a separate power waste arises despite the cutoff of power to the device.

Even while an event in the system is processed and another event is awaited, the system remains fed with AC power and consuming power.

Also, devices to be developed in the future to open the Internet of Things (IoT) era will apparently consume even more power as they will be equipped with more functionalities.

A Gartner report predicts that the IoT-related market will reach 300 billion and the number of devices connected to the internet will be up to 26 billion in the year 2020.

A need exists for an implementation of IoT along with a more efficient energy management scheme in preparation for places where more energy consumption is to occur.

For example, assuming that each household has 10 AC receptacles the own power consumption of which is 1 W, each household happens to waste 240 W daily and 87 KWh yearly even though the devices all are powered off. Under the assumption that the own power consumption of wireless Internet devices, modems, and energy management system is 40 W and the devices are not used for 10 hours or more daily, power consumption reaches 400 W daily and 146 KWh yearly.

In such case, yearly power waste will be 4,194 GWh if about 1,800 million of households in, e.g., South Korea, consume power. Where standby power is added thereto, even more power waste will be caused.

As such, the introduction of regulations and systems to save energy results in another waste of power consumption, which ends up going against the intended goal of energy savings.

### SUMMARY

The energy management system of the present invention may efficiently use energy through communication with a smart grid and measure power usage per electronic product (hereinafter, referred to as a device) to perform integration and integrate and monitor total power usage per local area. The energy management system may collect, analyze, store, and transfer, e.g., use patterns or data, through the Internet of Things (IoT) between devices and automatically cut off and control power waste in devices while the devices are not used, leading to efficient use of energy.

Also, the energy management system remotely (wiredly or wirelessly) controls devices through a smartphone or PDA. Where devices in, e.g., an office, building, and factory, are not in use, the energy management system automatically and completely cuts off the supply of power to the devices. Where all of the devices connected to the system are cut off and where the system terminates a control event and stays in a standby state, the system is cut off from power supply thereto to remove unnecessary power waste in the system, thereby minimizing power consumption and efficient management of energy.

In some embodiments of the present invention, the system also allows legacy receptacles (which simply have power connection functionality) to be put to use while performing the above-described functions.

According to some embodiments of the present invention, there is provided a system that may automatically connect all the devices to the system, measure power consumption in each device connected to the system, and remotely power on or off any device connected to the system. In an embodiment, a software application may be configured or a group may automatically be set to automatically and previously manage one or more peripheral devices, enabling a switch-on or switch-off based on power consumption in one or more master device.

The master and peripheral devices need not be connected with the same multi-outlet adapter.

For example, where all the computers (positioned in, e.g., a study room or bedroom) consume standby power, an Internet router (positioned in a living room) and a laser printer (positioned in the study room) may be set to automatically switch off.

In some embodiments of the present invention, there is provided a function that notifies the user of the use state of a device (through, e.g., a voice, alert sound, or image). Since all the devices connected to the system are monitored and controlled, it is critical to exactly identify each device. By such sensing and notifying functionality, a new device added to the system may be identified, and even where any one device is relocated from one receptacle to another managed by the system, life pattern data used in the previous receptacle may be, as it is, recognized, and automatically controlled depending on the life pattern.

The system is also designed to remotely or manually power on or off even when all the devices and/or smart receptacles remain completely cut off from power supply.

The system is also designed so that, when a request for managing peak power is received from a smart grid, the devices managed during the time are prevented from being manually powered on.

Meanwhile, even when the system remains cut off from power supply, if the user powers on a device, and the device sends, through wireless communication, a power-on signal that is then received by the system, the system is automatically supplied AC power and processes an event.

Legacy devices lack an external network communication unit for performing wired/wireless communication with an external network, a manual/remote power supply/cutoff unit, and a power measuring unit. To manage power usage for such a legacy device, a smart receptacle (refer to FIG. 3) is provided between the system and the device. The smart receptacle includes an internal network communication unit for wired/wireless communication with an internal network, a power supply/cutoff unit, a power measuring unit, and a microcontroller. The smart receptacle integrates power usage of the device, communicates data with the system, and if the device turns off, zeros the self-power consumption in the smart receptacle by completely cutting off the supply of power to the smart receptacle.

To manually and remotely supply and control power to a device, an AC receptacle (refer to FIG. 4) includes an insertion slot for inserting the power plug of the device and a means (a USB or Ethernet connector) for delivering pulsed power from the system to the manual/remote power supply/cutoff unit of the device.

According to other embodiments (e.g., the second embodiment) of the present invention, to manually and remotely supply and control power to a device, an AC receptacle may include an insertion slot for inserting the power plug of the device and a means (a cable for a USB or Ethernet connection) allowing the manual/remote power supply/cutoff unit in the AC receptacle to receive pulsed power from the system.

According to other embodiments (e.g., the third embodiment) of the present invention, there is provided a system that may measure power consumption in each device connected to the system, connect all the devices to the system, and remotely power on or off any device.

Also, the use pattern per device may be analyzed, and a per-season, or time period, control condition may be analyzed to be predictably controlled.

Even where any one device is relocated from one receptacle to another managed by the system, life pattern data used in the prior receptacle may be as it is, recognized, and automatically controlled depending on the life pattern.

Further, existing receptacles may be used, as they are, without the need for a separate construction, and a device having IoT functionality and an adapter-type receptacle are provided so that an existing normal device is connected with the receptacle, thereby efficiently managing power consumption.

Meanwhile, it is possible to automatically control the supply of power to the device and system that remain cut off power supply.

The system according to the above-described embodiments of the present invention enables energy savings to continue in an effective and efficient way without the user's involvement and changing the user's life pattern under minimum efforts. Further, the system is designed to perform IoT functions while performing an energy management operation.

According to at least some embodiments of the present invention, there may be provided an energy management system that is effective and efficient without the user's involvement while putting minimum effort into devices. Also, according to at least some embodiments of the present invention, existing receptacles may be connected, as they are, without a separate construction, thereby providing for an efficient energy management system.

As more and more devices come up with IoT functionality, power consumption is expected to increase in the future. The International Energy Agency (IEA) is recommending to figure out methods for reducing power consumption.

The present invention may reduce costs for constructing additional power stations and greenhouse gas emissions by cutting off unnecessary power waste.

### BRIEF DESCRIPTION OF DRAWINGS

FIG. 1 is a block diagram illustrating a configuration of an energy management system according to a first embodiment of the present invention;

FIG. 2 is a view illustrating the outer shape of a basic-type receptacle and a smart receptacle according to the first embodiment of the present invention;

FIG. 3 is a block diagram illustrating a configuration of a smart receptacle according to the first embodiment of the present invention;

FIG. 4 is a block diagram illustrating a configuration of a basic-type receptacle according to the first embodiment of the present invention;

FIG. 5 is a block diagram illustrating a configuration of a first type of device (a device that is not powered off for 24 hours) according to the first embodiment of the present invention;

FIG. 6 is a block diagram illustrating a configuration of a second type of device according to the first embodiment of the present invention;

FIG. 7 is a block diagram illustrating a configuration of a magnet switch that forcedly cuts off the power of a device of management upon managing peak power according to the first embodiment of the present invention;

FIG. 8 is a block diagram illustrating a configuration of a detachable module configured to be detachable from a device according to the first embodiment of the present invention;

FIG. 9 is a block diagram illustrating a configuration of a central management device of an energy management system according to the first embodiment of the present invention;

FIG. 10 is a block diagram illustrating a configuration of an energy management system according to a second embodiment of the present invention;

FIG. 11 is a view illustrating the outer shape of a receptacle according to the second embodiment of the present invention;

FIG. 12 is a view illustrating the outer shape of a lamp switch according to the second embodiment of the present invention;

FIG. 13 is a block diagram illustrating a configuration of a receptacle according to the second embodiment of the present invention;

FIG. 14 is a block diagram illustrating a configuration of a lamp switch according to the second embodiment of the present invention;

FIG. 15 is a block diagram illustrating a configuration of a normal device to which the second embodiment of the present invention is applicable;

FIG. 16 is a block diagram illustrating a configuration of a central management device applied to a smart meter according to the second embodiment of the present invention;

FIG. 17 is a view illustrating an example of an internal major circuit configuration of a manual/remote power supply/cutoff unit that is applicable to a receptacle or a lamp switch according to the second embodiment of the present invention;

FIG. 18 is a block diagram illustrating a configuration of a first type of device (a device that is not powered off for 24 hours) to which the second embodiment of the present invention is applicable;

FIG. 19 is a view illustrating another example of an internal major circuit configuration of a manual/remote power supply/cutoff unit that is applicable to a receptacle or a lamp switch according to the second embodiment of the present invention;

FIG. 20 is a block diagram illustrating a configuration of an energy management system according to a third embodiment of the present invention;

FIG. 21 is a block diagram illustrating a configuration of a first type of IoT device according to the third embodiment of the present invention;

FIG. 22 is a block diagram illustrating a configuration of a second type of IoT device according to the third embodiment of the present invention;

FIG. 23 is a view illustrating the outer shape of a receptacle according to the third embodiment of the present invention;

FIG. 24 is a block diagram illustrating a configuration of a receptacle according to the third embodiment of the present invention;

FIG. 25 is a block diagram illustrating a configuration of a central management device according to the third embodiment of the present invention; and

FIG. 26 is a block diagram illustrating a configuration of a lamp switch according to the third embodiment of the present invention.

### DESCRIPTION OF EXEMPLARY EMBODIMENTS

Hereinafter, preferred embodiments are described in detail with reference to the accompanying drawings to be easily be practiced by one of ordinary skill in the art to which the present invention pertains

However, when determined to make the subject matter of the present invention unnecessarily unclear, known functions or configurations may be skipped from the detailed description of the operational principle of the preferred embodiments of the present invention.

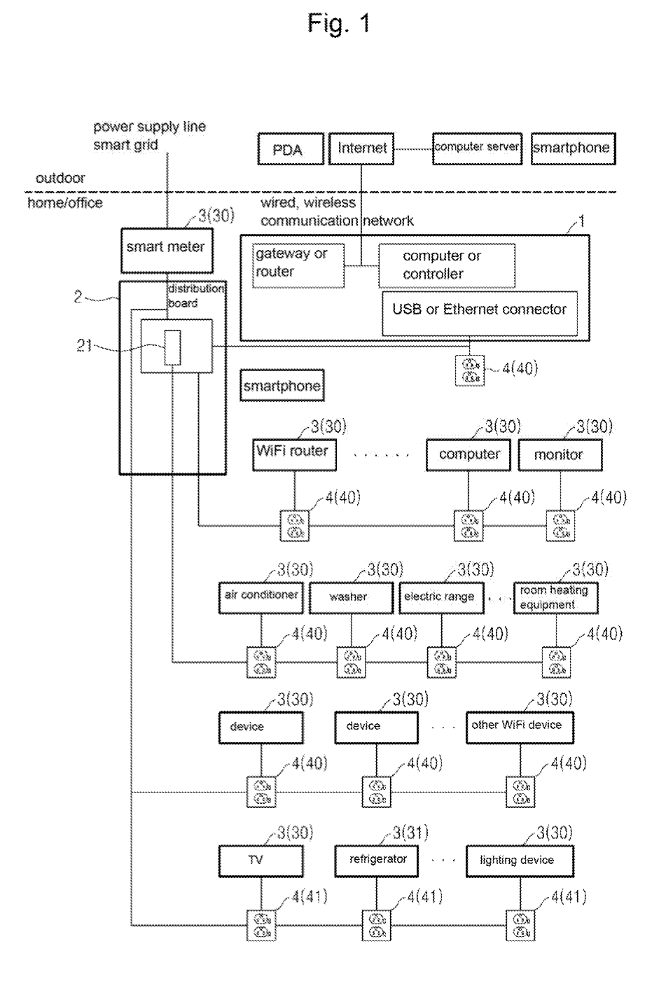

FIG. 1 is a block diagram illustrating a configuration of an energy management system according to a first embodiment of the present invention. Referring to FIG. 1, the energy management system of the present invention is a wide area network for home or office, which includes a central management device 1 (applicable to, e.g., a smart meter, a wall pad, a separate dedicated device, a PC, a smart TV, or a smart refrigerator), at least one master device (at least one of reference numerals 3), and multiple slave devices (the remainder of the reference numerals 3 except for the master device(s))

The slave devices 3, as multiple home or office devices, such as a TV, a PC, a game console, an oven, a washer, a lamp, and a room cooler/heater, may be remotely controlled and may measure energy. The slave devices may wiredly or wirelessly communicate with the master device and may wiredly or wirelessly communicate with the outside, e.g., a portable device, such as a computer, a smart phone, or a tablet PC, to be managed.

For an energy management control operation of the present invention, software or an application (‘app’) executed on a computer or portable device provides a user interface that remotely accesses the central management device 1 through, e.g., a server, to collect, analyze, and manage energy management data and to control devices connected with the system. The user, even when positioned where the devices are absent, may remotely access the central management device 1 through a modem, a router, and an Internet service provider, and remotely access the central management device 1 to perform measurement and control.

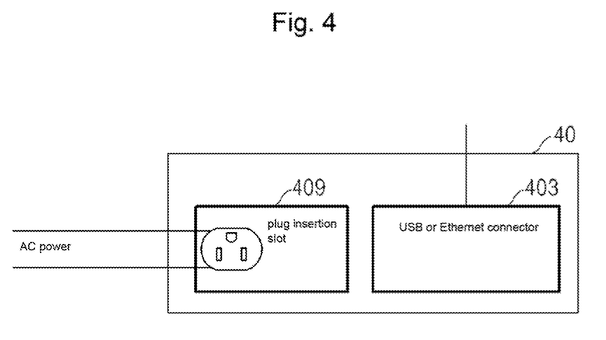

According to an embodiment of the present invention, a power plug of the device 3 is inserted into a plug slot 409 of a basic-type receptacle 4 (refer to 40 of FIG. 4), and a USB or Ethernet connection terminal of the device is connected to a USB or Ethernet connector 403 of the basic-type receptacle 4 so that power-on or power-off may be remotely performed even when the supply of power to the device is cut off.

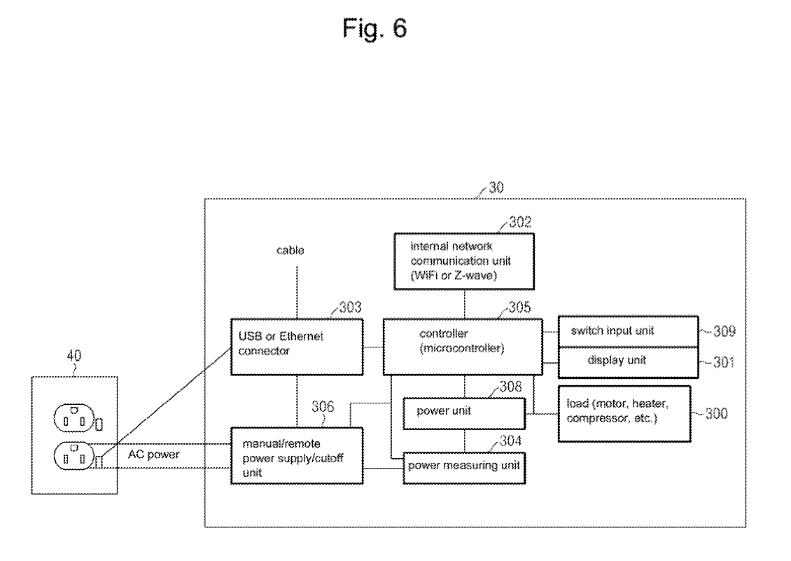

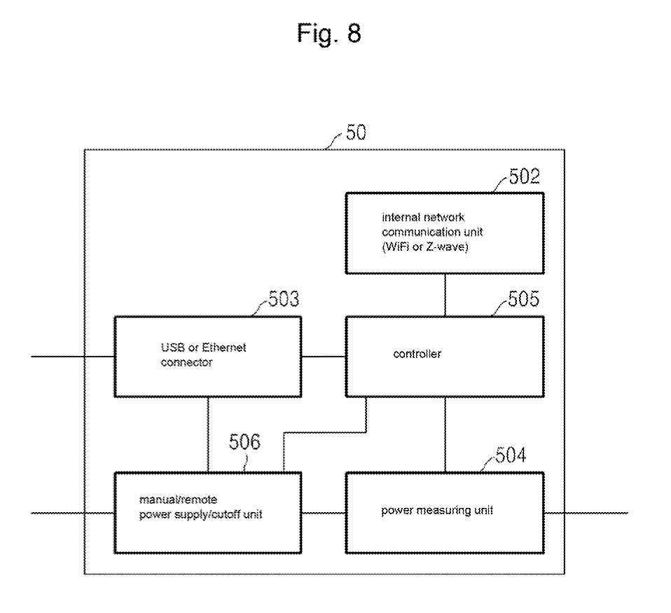

The slave devices 3 (refer to FIG. 6) may have a USB or Ethernet connector to be connected to the basic-type receptacle 40, a manual/remote power supply/cutoff unit (refer to Korean Patent No. 10-0094210) to manually or remotely supply power, or cut off the supply of power, to the device, a current measuring unit for measuring a power consumption, and an internal network communication unit that may wiredly or wirelessly perform internal network communication to communicate various data, such as data of integrated power, device ID, or use time, with the system. In the above description, the term “manual” or “remote” in the manual/remote power supply/cutoff unit means that it has a configuration in which its on/off manipulation may manually be conducted by the user or it may further perform, at least, an on operation by a control signal provided remotely. Meanwhile, unless it is desired to connect the slave device 3 to the system, a detachable module (refer to FIG. 8), as a separate part, in which the components in charge of the functions of the present invention in the slave device have been separately implemented to be individual modules may be designed to be detachably mounted at a predetermined position of the device, so as to allow customers reduced costs. Accordingly, the device may independently be used free of a detachable module. If needed in the future, a detachable module may be purchased and mounted in the device by which the detachable module may automatically be registered in the system and remotely controlled and managed. Such detachable module may have a structure In which, e.g., an end of the detachable module is connected with a connector that connects the device with the receptacle and the other end of the detachable module is connected with the receptacle.

Meanwhile, a smart receptacle (refer to 41 of FIG. 3) may be provided to connect an existing normal device being used, instead of the slave device to which the embodiment of the present invention applies, to the system and control the device. In this case, if the device has been remotely turned off, an intermediate involvement may be required to manually turn on the device.

In order to enable recognition whichever AC receptacle the device is connected to, a unique ID (e.g., a country code, manufacturer code, product code, serial No., OS version (terminal), or standby power value) may be assigned to the device. The unique ID may be entered and stored in an internal memory of the device upon manufacturing the device, and data can be transmitted or received in a proper format of data packet containing the ID code upon communication. So doing enables the device to be recognized anywhere in the world through international standards in the future, enabling easier and efficient energy management in all the countries.

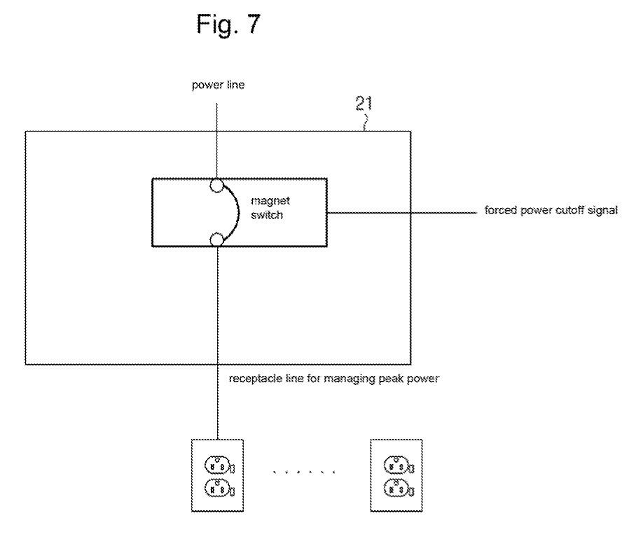

According to an embodiment of the present invention, there may be provided a means (refer to FIG. 7) that forcedly cuts off power to a power line so that a designated device cannot manually be used where the power the device has been cut off from power supply upon receiving a request for managing peak power from a smart grid to manage peak power.

Since both manual and remote control are possible, at least one of the master device or peripheral device or all the devices connected to the basic-type receptacle or smart receptacle may be managed and controlled for power supply through computer software or a smartphone or tablet PC app depending on the system configuration.

According to an embodiment of the present invention, the energy management system may include a Wi-Fi module that follows an industry standard that converts power measurement data and remote control commands sent or received to/from the master device or slave device to be allowed by a Wi-Fi (or Z-wave, or in the future, Li-Fi)-supportive computer, smartphone, and tablet PC, enabling device control and data analysis through a user-friendly bi-lateral interface of PC software and app, instead of existing button-type driving remote controllers which have little or no chance of being upgraded with new functionalities in the future.

Some recent home or office automation systems also have the same Wi-Fi conversion function that enable control by a Wi-Fi available computer, smartphone, or tablet PC. However, they connect to an existing Wi-Fi network. By contrast, some embodiments of the present invention may form a new Wi-Fi network even when no existing Wi-Fi network is present.

Alternatively, the system of the present invention provides a wireless Wi-Fi network that may cover some blind spots in a place where a computer, smartphone, or tablet PC is present.

In another embodiment, whenever the device is connected or removed from the receptacle, the user may be notified of it through computer software or an app to enhance the user's convenience. Accordingly, the user may immediately be notified of insertion of an unsecured plug or wrong removal of a plug, thereby protecting main devices to ensure proper operation.

Meanwhile, a remote-control webpage, which may be provided in an Internet server to enable remote user access, includes an authentication means to authenticate the user with an ID and a password, and the remote-control webpage has a security function.

Where devices are operated in interoperation with each other, a group number may be assigned to group them so that peripherals may be supplied power or cut off from power supply according to the state of the computer, as if a computer, a monitor, and a printer are. Although several computers are used, e.g., in an office, a group may automatically be designated to be controlled regardless of the position of receptacles.

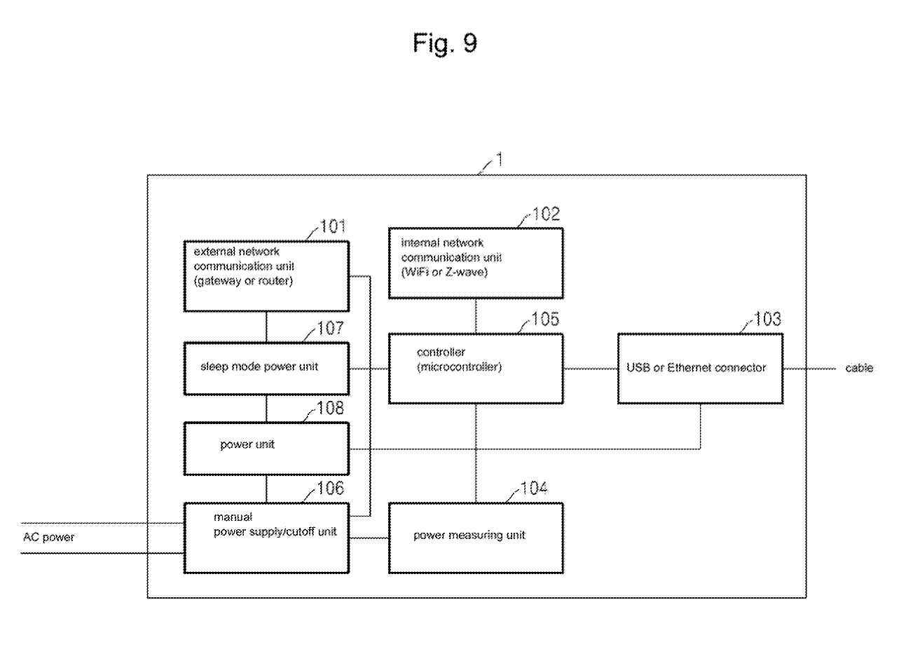

FIG. 9 is a block diagram illustrating a configuration of a central management device of an energy management system according to the first embodiment of the present invention. Referring to FIG. 9, an external network communication unit 101 in a central management device 1 may be connected with one or more networks. For example, a gateway or router, such as the FastPath of Kinetic Corporation which may connect the AppleTalk network with the Ethernet network may be configured as a piece of external connecting equipment to enable communication with an external portable device (e.g., a smartpbone or tablet PC). An internal communication unit 102 configured of a Wi-Fi or Z-wave (Li-Fi is applicable in the fixture) to enable wireless short-range communication on an internal network may be provided to communicate data with the devices 3 constituting the system.

The gateway is connected with various access networks to provide a network service. PSTN, ADSL, FTTH, or other various communication networks may be adopted as the access networks. The gateway is XML-based, compatible with at least one or more standard protocols, as well as products of (third party) solution companies, and may be implemented to support, e.g., Modbus, BACnet, Lonworks, DNP3, DLMS, ANSI C12.22, o IEC61850. The gateway may also perform wired/wireless communication RS485, ZigBee, PLC, Wi-Fi, or LAN functions and may expand the plug-and-play type.

A USB or Ethernet connector 103 (or a communication cable for use therein) may be provided which connects with the devices 3 to provide control signals (pulsed power) to control the supply or cutoff of supply of power to each device 3 constituting the system. A power measuring unit 104 for measuring self-power consumption in the central management device 1 may be provided.

Meanwhile, the central management device 1 includes a microcontroller, as a controller 105 to collect, compute, analyze, determine, control, and manage all the data (e.g., data of power usage, or time or date of use per device) and a solid-state drive (SSD) as an internal memory (not shown) to secure a smooth speed in storing, reading, or writing data.

Here, a touchscreen input device, such as a wall pad (not shown), or a keyboard (not shown) may be configured as an input device for a user interface of the central management device 1, allowing the user to easily enter a control program for, e.g., interworking, controlling, or grouping, to the central management device 1 through the touchscreen input device or keyboard or automatically perform grouping so that the central management device 1 may perform a control operation according thereto.

A manual power supply/cutoff unit 106 is provided as a means to cut off the power supplied to the central management device 1 when event processing is ended. The manual power supply/cutoff unit 106 prevents unnecessary power consumption by cutting off the supply of AC power in a standby state after event processing is done. The term ‘manual’ in the manual power supply/cutoff unit 106 means that added is a configuration for the user to manually turn on/off as set forth in Korean Patent No. 10-0094210, and it should be noted that the term does not necessarily mean that it is configured to be operated only by the user's manual manipulation.

In this state, a sleep mode power unit 107 (which may be configured of a super capacitor that is charged upon supplying power or a battery for charging) is provided to supply power only to the controller 105 and the communication units 101 and 102, which are configured of a gateway or router and a Wi-Fi or Z-wave (Li-Fi is applicable in the future) to sense an external or internal input signal, minimizing self-power consumption in the system.

The central management device 1 also includes a power unit 108 that receives external AC power, converts the AC power into operation power for the central management device 1, and provides the operation power to each internal function unit of the central management device 1. The manual power supply/cutoff unit 106 is provided on the path along which the external AC power is provided to the power unit 108 to block or connect the path along which the power is supplied.

To prevent such situation where AC power remains cut off too long so that sleep mode power is discharged too excessively to perform its normal operation, the power is periodically checked, and if it reaches a predetermined voltage VT1 or less, the microcontroller controls the manual power supply/cutoff unit 106 to supply power to the power unit 108, thereby suppling power to the sleep mode power unit to charge the sleep mode power unit. Thereafter, when the charging is complete, the microcontroller controls the manual power supply/cutoff unit 106 to cut off the supply of power, freeing the central management device of power consumption.

FIG. 4 is a block diagram illustrating a configuration of a basic-type receptacle according to the first embodiment of the present invention. Referring to FIG. 4, a basic-type receptacle 40 is connected with an external AC power source and includes an insertion slot 409 for inserting a power plug of a device 3 and a USB or Ethernet connector 403 to deliver pulsed power from the central management device 1 to the device 3 (i.e., a manual/remote power supply/cutoff unit inside the device) and to enable wired communication.

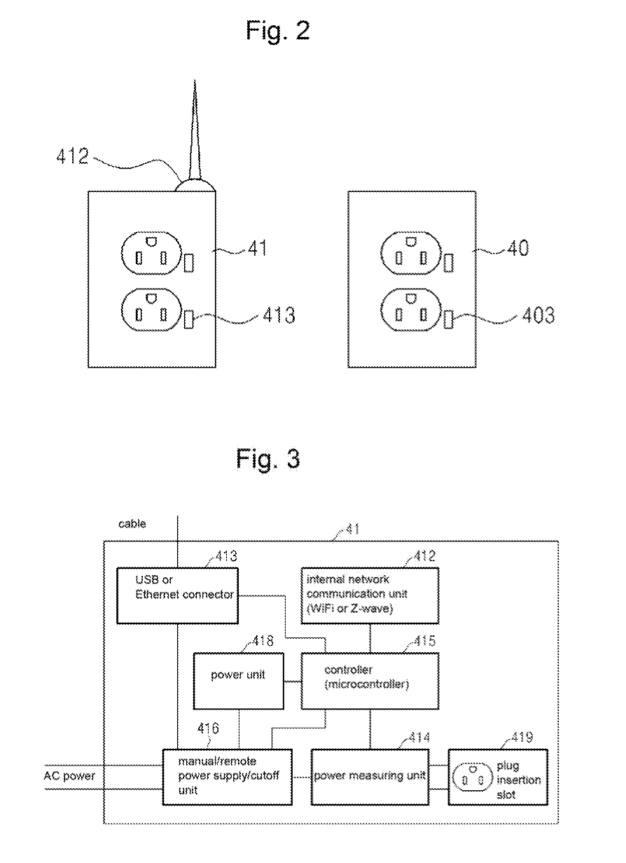

The receptacles 41 and 40 shown in FIG. 4 and FIG. 3, which are described below, may be configured to have an outer appearance as shown in FIG. 2.

FIG. 3 is a block diagram illustrating a configuration of a smart receptacle according to the first embodiment of the present invention. Referring to FIG. 3, a smart receptacle 41 may provide a function for managing existing devices which are already in purchase and use. The smart receptacle 41 includes an insertion slot 419 for inserting of the power plug of a device, a manual/remote power supply/cutoff unit 416 that is provided on a path along which external AC power is provided to the insertion slot 419 to conduct or block the path, a USB or Ethernet connector 413 having a function for delivering pulsed power from the central management device 1 and to which a connecting device can be connected to perform wired communication. The smart receptacle 41, when operated manually or receiving pulsed power from the central management device 1 to turn on the device, controls the operation of the manual/remote power supply/cutoff unit 416 to supply AC power to the plug insertion slot 419 so that power is supplied to the device. The smart receptacle 41 may also include a power unit 418 that receives external AC power through the manual/remote power supply/cutoff unit 416 and converts the external AC power into internal operation power, a power measuring unit 414 for measuring power consumption in the device connected through the plug insertion slot 419, an internal network communication unit 412 (a Wi-Fi module or a Z-wave module) for wirelessly communicating the measured information, and controller 415 (e.g., a microcontroller) that controls the overall operation of the smart receptacle 41.

The operation of the smart receptacle 41 configured as above is described. When power is initially supplied, the standby power of the device connected with the smart receptacle 41 is computed and automatically set, and a smart receptacle ID is sent to the central management device 1 and registered in the central management device 1. Thereafter, when the device ends its operation and powers off, the device is determined to have been powered off by identifying that standby power flows through the power measuring unit 414, data collected during the course is sent to the central management device 1, and the manual/remote power supply/cutoff unit 416 is controlled to cut off the AC power supplied to the smart receptacle 41 itself, thereby completely freeing the smart receptacle 41 of its own power consumption.

As such, the central management device 1 manages information about the device connected with the smart receptacle 41 using the ID of the smart receptacle.

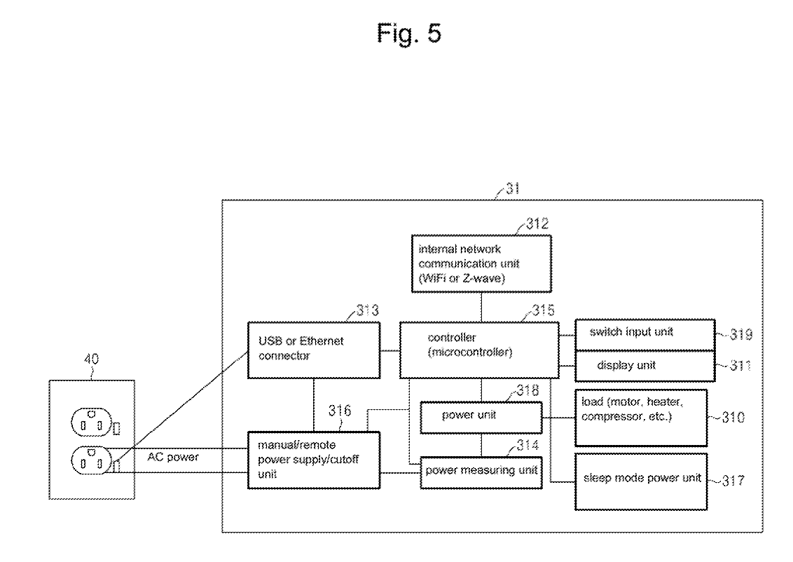

FIG. 5 is a block diagram illustrating a configuration of a first type of device (a device that is not powered off for 24 hours) according to the first embodiment of the present invention. Referring to FIG. 5, a first type of device 31 (e.g., a kimchi refrigerator, a refrigerator, an electric range, a bidet, a hand drier, or a water purifier) continuously supplying power for 24 hours includes a manual/remote power supply/cutoff unit 336 that is provided on an input path of external AC power from a basic-type receptacle 40 to conduct or block the path, a power unit 318 that receives the external AC power through the manual/remote power supply/cutoff unit 316 to generate driving power for each internal function unit and driving power for a load 310 (e.g., a motor, a heater, or a compressor), a power measuring unit 314 that measures power provided to the power unit 318 to measure power consumption in the device 31, and an internal network communication unit 312 configured of, e.g., a Wi-Fi or 2-wave module, for communication to deliver the measured power to a central management device and inter-device communication.

The device 31 also includes a USB or Ethernet connector 313 that enables wired communication and delivery of pulsed power provided from the central management device 1 through the basic-type receptacle 40 so that, when manually operated or receiving pulsed power for turning on the device from the central management device 1, it controls the operation of the manual/remote power supply/cutoff unit 316 to supply power to the device. At this time, when a control condition for the device (e.g., when a temperature condition set in a refrigerator is met), the manual/remote power supply/cutoff unit 316 is controlled to cut off the AC power, preventing power waste. Unless the control condition is met, the manual/remote power supply/cutoff unit 316 is controlled again to supply the AC power to the inside of the device so that the operation continues until the driving condition is met. If the driving condition is met, the above-described control is repeated.

In this case, the device 31 also includes a sleep mode power unit 317 for supplying power only to the internal network communication unit 312 and the controller 315 to minimize power consumption by activating minimum functions. The sleep mode power unit 317 may be configured of, e.g., a super capacitor that is charged upon supplying power, or a battery for charging.

The first type of device 31 may also include a controller 315 (e.g., a microcontroller) that controls the overall operation of the device 31, a switch input unit 319 having various switches for receiving manipulation of the operation of the device from the user, and a display unit 311 that shows the user information for receiving the operation state and operation settings of the device.

Such first type of device 31 may be configured to store an ID when manufactured and shipped out, so as to be automatically registered and recognized by the central management device whatever receptacle it is connected to.

FIG. 6 is a block diagram illustrating a configuration of a second type of device according to the first embodiment of the present invention. Like the first type of device 31, a second type of device 30 shown in FIG. 6 may include a manual/remote power supply/cutoff unit 306, a load 300, a power unit 308, a power measuring unit 304, an internal network communication unit 302, a USB or Ethernet connector 303, a switch input unit 309, a display unit 301, and a controller 305, the configuration and operation of which may be similar to those of the relevant components of FIG. 5. However, the second type of device 30 of FIG. 6 does not include a configuration corresponding to the sleep mode power unit 317 of FIG. 5.

FIG. 7 is a block diagram illustrating a configuration of a magnet switch that forcedly cuts off the power of a device of management upon managing peak power according to the first embodiment of the present invention. Referring to FIG. 7, a magnet switch 21 is connected in series with a peak power management power line that is provided in a distribution board 2 as a means provided to manage peak power according to some embodiments of the present invention. When the central management device 1 receives a request for managing peak power from a smart grid, the central management device 1 sends a forced power cutoff signal to the magnet switch 21 of the distribution board 2 to open the contacts of the magnet switch 21 to forcedly cut off the supply of power to a receptacle line for management of peak power, thereby stopping using the device. By doing so, peak power is managed. When receiving a peak power management release signal, the central management device 1 controls the management switch 21 to connect the contacts of the magnetic switch 21 and to resume the supply of power to the receptacle line for management of peak power.

FIG. 8 is a block diagram illustrating a configuration of a detachable module configured to be detachable from a device according to the first embodiment of the present invention. Referring to FIG. 8, a detachable module 50 may separately include only main units of the components included in the device of FIG. 5 or 6. For example, the detachable module 50 may include a manual/remote power supply/cutoff unit 506, a power measuring unit 504, an internal network communication unit 502, a USB or Ethernet connector 503, and a controller 505. In some cases, the separate controller 505 may not be included in the detachable module 50, and its corresponding function may instead be added to the microcontroller that controls the overall operation of the connected device.

The customer may not desire to connect a device to the central management device. In this case, the customer may independently use a device that is free of a detachable module 50, and as necessary in the future, get and mount a detachable module 50 In the device. The detachable module 50 may be automatically registered in the central management device and remotely controlled and managed.

In some embodiments of the present invention, a software application program provides a user interface to display a power measurement and on/off state for each device in the system. Each device may remotely be turned on or off through the software application program.

A past instantaneous power and power consumption history may also be searched and displayed through the software application program. Also, the use pattern of an individual device may be reviewed by providing an analysis that provides, in graphics, power usage per minute, hour, week, month, or year.

In order to minimize power consumption in the system in the standby state after all of the devices are powered off or event processing is ended, the system is also powered off to which case sleep mode power is supplied only to the communication unit and the controller (microcontroller) which are minimum means for checking the occurrence of an event. In this case, there would be expected to be a moment when the power consumption is 100% blocked and the power supplied to the overall system is zeroed, (a so-called ‘energy consumption zero building’ may be implemented.)

When a communication signal is wirelessly received from the outside or the device is powered on to use the device in the above state, the device wiredly/wirelessly communicates with the central management device. At this time, the central management device receiving the signal controls a manual power supply/cutoff unit (whose detailed configuration may be similar to that disclosed in Korean Patent No. 10-0094210) for supplying power to the central management device to supply power to an internal power unit, thereby performing a system-on event control.

A control procedure when an event occurs is described below in greater detail.

[Step 1] is the step of system initialization. When power is applied to the central management device, the central management device controls the manual/remote power supply/cutoff units of all of the devices connected thereto to supply power to all the devices, activating the devices. The central management device communicates with the connected devices to verify and register device IDs (packet data configured of, e.g., a country code, manufacturer code, product code, serial No., or OS version). Thereafter, the central management device sends registration complete signals to devices for which registration has been finished, and devices verified for registration perform control to cut off power on their own.

[Step 2: Step of processing control request from outside] When the central management device receives a control signal from the outside while being cut off from power supply, power is supplied to the central management device. If the central management device is in the state of being supplied power, the central management device checks the ID and password in the received signal to perform a security check. If the result of security check shows no abnormality, the central management device identifies whether the controlled device is a device being currently used and sends a control signal to the device. Accordingly, the controlled device performs an operation according to the control signal and sends a result of performing the operation to the central management device. The central management device sends a control complete signal to the outside.

[Step 3] When a control event of a device being not currently used occurs, pulsed power is supplied to the manual/remote power supply/cutoff units of devices powered off thereby activating the powered-off devices. Power is supplied to all of the devices. Thereafter, if the central management device sends the ID of a device that the central management device is to control, devices which do not correspond to the ID, automatically control their manual/remote power supply/cutoff units to completely cut off the supply of power to the devices. The device of the ID performs an operation according to the control signal and sends a result of performing the operation to the central management device. Accordingly, the central management device sends a control complete signal to the outside.

[Step 4] Upon receiving a request for controlling a device when another device is being used, the central management device may repeatedly perform the control of step 3.

[Step 5] Upon receiving a signal for managing peak power from a smart grid, the central management device controls the magnet switch to cut off the supply of power to the power line for management of peak power so that the devices cannot be used manually, and upon receiving a peak power management release signal, the central management device controls the magnet switch to resume tire supply of power to the power line for management of peak power.

[Step 6] An in-group, interoperative control step performs control to supply power to all the devices when the computer (i.e., the master device) is turned on manually or by the outside and supplies, as it does, power to the peripheral device (i.e., a slave device, e.g., a monitor, printer, or speaker) interoperating with the computer, while controlling the manual/remote power supply/cutoff units of the remaining devices, which are operated independently, to cut off the supply of power to the remaining devices. The peripheral device measures power consumption during a predetermined time (a ‘determination time’), and if the standby power is larger, the peripheral device is determined to be one used in interopration, and the peripheral device transmits information indicating that the device is an interoperating device to the central management device. The central management device receives the transmitted data and performs the operation of automatic registration in group. At this time, if the power consumption in the peripheral device maintains the standby power, the device falls within a different group, and thus, such control may be performed that the peripheral device may cut off power on it own.

[Step 7] If the master device (e.g., a computer) interoperatively controlled in step 6 is manually turned off, the master device (computer) transfers various data, such as a power-off signal and an integrated power value, through communications to the central management device, and the central management device may send a power-off command to the peripheral device (a slave device) registered in the same group as the computer. At this time, when the slave device receives the power-off signal, the slave device cuts off the supply of power on its own.

Upon remotely receiving a computer off signal, the central management device sends end signals to the slave devices in the same group as the computer, and the computer and slave devices receiving the signals may send their various data, e.g., integrated power values, to the central management device and then terminate.

[Step 8] Upon power-off, all the devices transmit the IDs, use times, integrated power values, end signals, or other management data to the system and cut off power supply.

[Step 9] If event processing is ended, the central management device performs control to cut off AC power to reduce power consumption in the central management device and to supply sleep mode power only to the receive end (the gateway, communication unit, and microcontroller) for receiving a remote input signal so as to operate a minimum function. The central management device may perform control to supply AC power to the central management device upon receiving an occurrence of an event.

[Step 10] To prevent the sleep mode power from being discharged, the sleep mode power is periodically checked, and power is supplied before sleep mode power is reduced to a reference voltage or less, and the AC power may be cut off if the sleep mode power is fully charged.

Efficient energy management is rendered possible by the above-described configuration and control operation of the central management device.

[Second embodiment] Meanwhile, the scheme in the configuration according to the first embodiment basically proposes that device IDs are basically set by the manufacturer upon manufacturing the devices to distinguish the devices from each other. The scheme, however, would take too long to be applicable to all the manufacturers and is thus expected to be difficult to put in widespread use.

The second embodiment of the present invention addresses such issue.

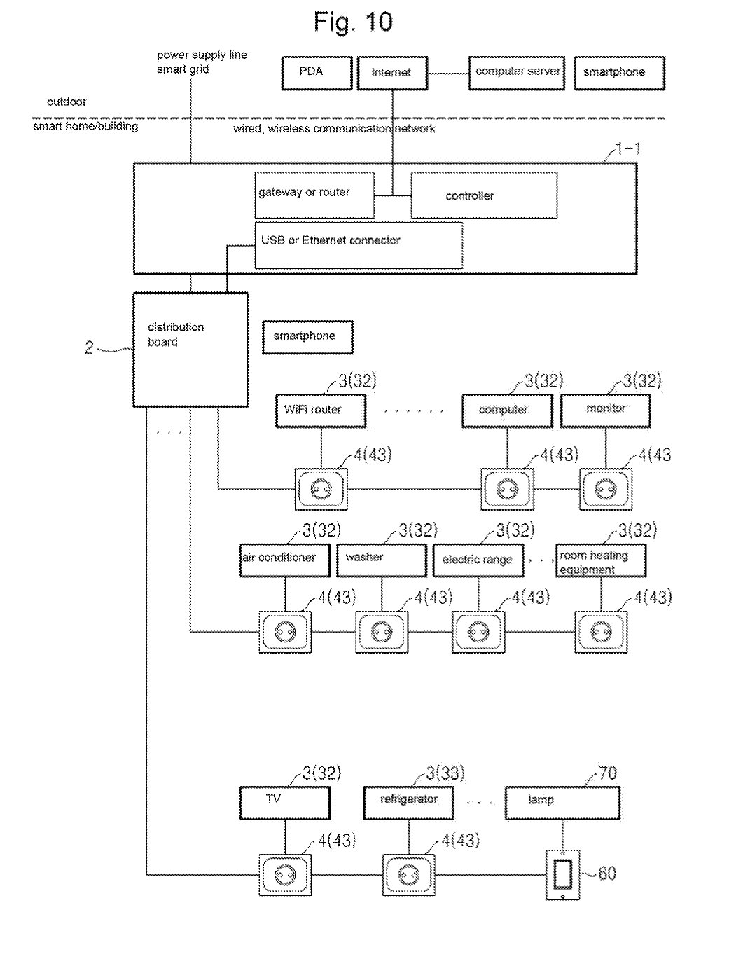

FIG. 10 is a block diagram illustrating a configuration of an energy management system according to a second embodiment of the present invention. Referring to FIG. 10, the energy management system of the present invention, similar to the configuration of FIG. 1, is a wide area network for home or office including a central management device 1-1 (the example of FIG. 10 represents the state of it having been applied to a smart meter), at least one master device (at least one of reference numerals 3), and multiple slave devices (the remainder of the reference numerals 3 except for the master device(s)).

At this time, the master device and the slave terminals 3 may be multiple home devices or office devices, such as a typical TV, a PC, a game console, an oven, a washer, a light, or a room cooler/heater, and the role of the master device and slave device is configured to be actually performed by receptacles 4 (in addition, a lamp switch 60 as well) connected to the devices according to the second embodiment of the present invention.

In other words, each device is connected to the receptacle 4 or the lamp switch 60, and the device connected to the capacitance 4 and the lamp connected to the lamp switch 60 may remotely/manually be controlled, and it may be possible to measure power usage of each device and to analyze and manage the use time period or use pattern per day or month.

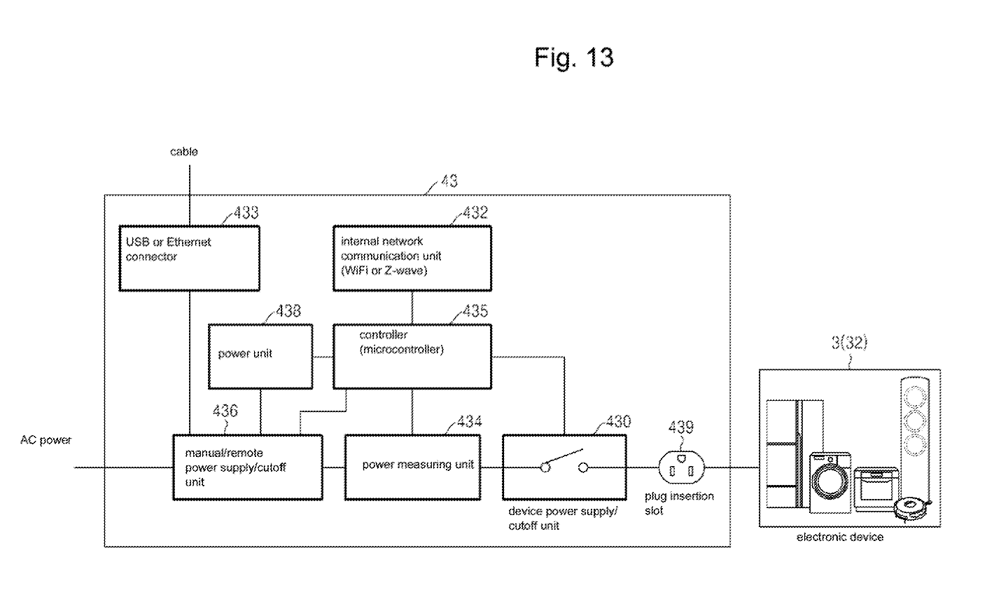

In some embodiments, each device is connected to the receptacle 4 (e.g., 43 of FIG. 13) by inserting the power plug of the device to the receptacle 43. The receptacle 43 includes a manual/remote power supply/cutoff unit that enables connection to the central management device 1-1 via a USB, Ethernet, or its corresponding cable to manually or remotely supply power or cut off the supply of power to the device so that the device can remotely be turned on or off while remaining cut off from power supply, a current measuring unit for mesuring power consumption, and an internal network communication unit enabling wired or wireless communication to transmit or receive integrated power data, receptacle ID, use time, and various data to/from the central management device 1-1.

In order to automatically generate and register IDs of the receptacle and lamp switch, if the IDs overlap each other, a different ID may randomly be generated. The respective unique IDs of the receptacles or the lamp switches may be generated while communicating between the receptacles, between the lamp switches, or during communication with the central management device, and the IDs may be stored and registered in the own memories of the receptacles and the light switches. Such IDs may also be registered in the central management device.

In some embodiments, at a peak power use time, an alert, message, or voice may be sent to the user to induce the user to use the device in a time period when a low power bill applies.

In an embodiment, there is provided a means that supplies power to the devices or lamps if the central management device supplies control signals (pulsed power) to the devices or lamps via the cables connected to the receptacles or lamp switches to remotely control the devices or lamps, and all the receptacles and lamp switches are supplied power, verify their IDs, and if the IDs are verified. Receptacles and lamp switches for which the IDs are not the ones of the receptacles and lamps cut off power supply thereto, freeing them of power consumption.

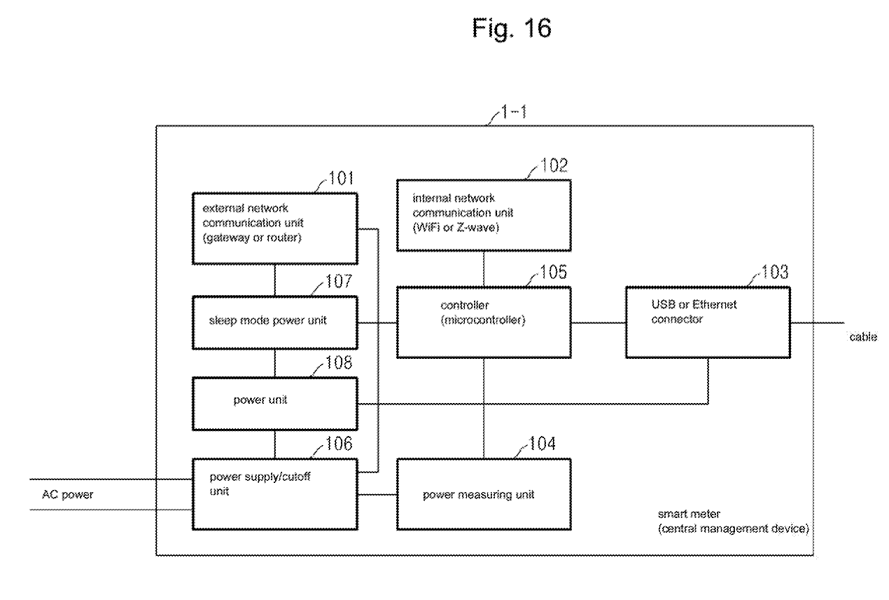

FIG. 16 is a block diagram illustrating a configuration of a central management device applied to a smart meter according to the second embodiment of the present invention. Referring to FIG. 16, as compared with the structure according to the first embodiment of FIG. 9, the central management device 1-1 according to the second embodiment of the present invention mostly has the same configuration and operation except for being applied to a smart meter. Of course, the smart meter has a basic configuration for measuring power usage, which is however omitted from FIG. 16.

Although the application of the central management device 1-1 to a smart meter as shown in FIG. 16 is described, other embodiments of the present invention may also be applicable to, e.g., a smart TV or smart refrigerator.

FIG. 13 is a block diagram illustrating a configuration of a receptacle according to the second embodiment of the present invention. Referring to FIG. 13, the receptacle 43 according to the second embodiment of the present invention includes an insertion slot 439 for inserting the power plug of a device 3 (32) and a USB or Ethernet (or corresponding) connector that transfers a control signal (pulsed power) from a central management device to a manual/remote power supply/cutoff unit 436 of the device 3 and enables wired communication. The receptacle 43 also includes a manual/remote power supply/cutoff unit 436, as a means to manually/remotely supply or cut off the supply of AC power, a power unit 438 that supplies power necessary for the receptacle 43, and a controller (microcontroller) 435 that comprehensively controls all of the functions of the receptacle 43. The controller 435 stores a use time period, use time, power usage measurements, and various data, generates an ID, stores the ID in a memory (EE-PROM (not shown)), and is in charge of communication.

Also configured is a device power supply/cutoff unit 430 that is installed on a power path between the manual/remote power supply/cutoff unit 436 and the insertion slot 439 to conduct or block the power supply path under the control of the controller 435. The controller 435 controls the operation of the device power supply/cutoff unit 430 so that, upon remote control, the receptacle 43 is supplied power, and only when its ID is verified, supplies power to the device plugged into the power plug insertion slot 439, thereby preventing unnecessary power waste in the device.

The receptacle 43 also includes a power measuring unit 434 that is installed on a power path between the manual/remote power supply/cutoff unit 436 and the insertion slot 439 to measure the standby power and power usage of the device and an internal network communication unit 432 implemented to be a Wi-Fi or Z-wave module to perform the function of communicating with other receptacles or a central management device.

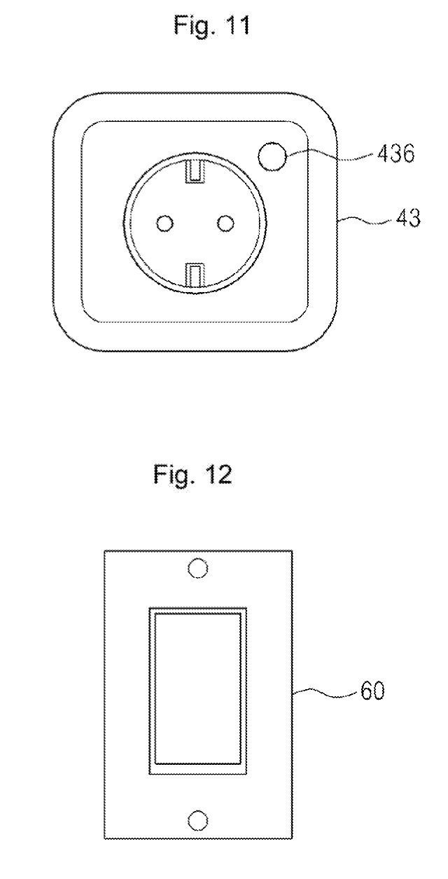

The receptacle 43 so configured may have an outer shape as shown in FIG. 11.

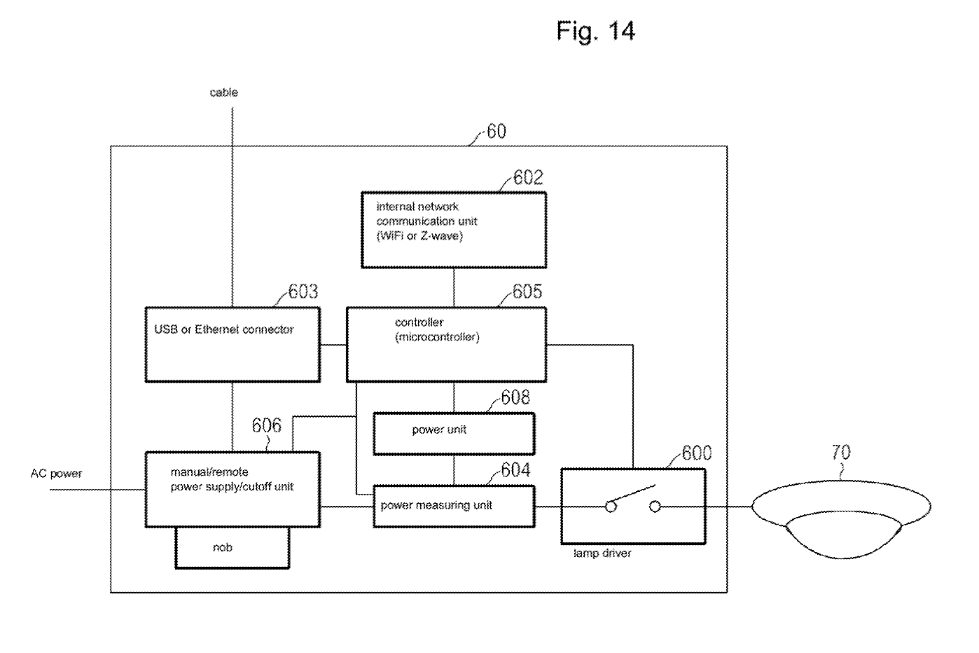

FIG. 14 is a block diagram illustrating a configuration of a lamp switch according to the second embodiment of the present invention. Referring to FIG. 14, the lamp switch 60 according to the second embodiment of the present invention includes a lamp driver 600 connected with a lamp 70 to drive the lamp 70 and a USB or Ethernet (or corresponding) connector 606 that transfers a control signal (pulsed power) from a central management device to a manual/remote power supply/cutoff unit 606 of the lamp switch 60 and enables wired communication. The lamp switch 60 also includes a manual/remote power supply/cutoff unit 606, as a means to manually/remotely supply or cut off the supply of AC power, a power unit 608 that supplies power necessary for the lamp switch 60, and a controller (microcontroller) 605 that comprehensively controls all of the functions of the lamp switch 60. The controller 606 stores a use time period, use time, power usage measurements, and various data, generates an ID, stores the ID in a memory (EE-PROM (not shown)), and is in charge of communication. At this time, the controller 605 controls the operation of the lamp driver 600 so that, upon remote control, the lamp switch 60 is supplied power, and only when its ID is verified, supplies power to the lamp connected with the lamp driver 600, thereby preventing unnecessary power waste in the lamp.

The lamp switch 60 also includes a power measuring unit 434 that is installed on a power path between the manual/remote power supply/cutoff unit 606 and the lamp driver 600 to measure the standby power and power usage of the lamp 70 and an internal network communication unit 602 implemented to be a Wi-Fi or Z-wave module to perform the function of communicating with other lamps or a central management device.

The lamp switch 60 so configured may have an outer shape as shown in FIG. 12. At this time, a switch that the user manipulates in the lamp switch 60 may correspond to a manual manipulation switch that is implemented to be part of the configuration of the manual/remote power supply/cutoff unit 606.

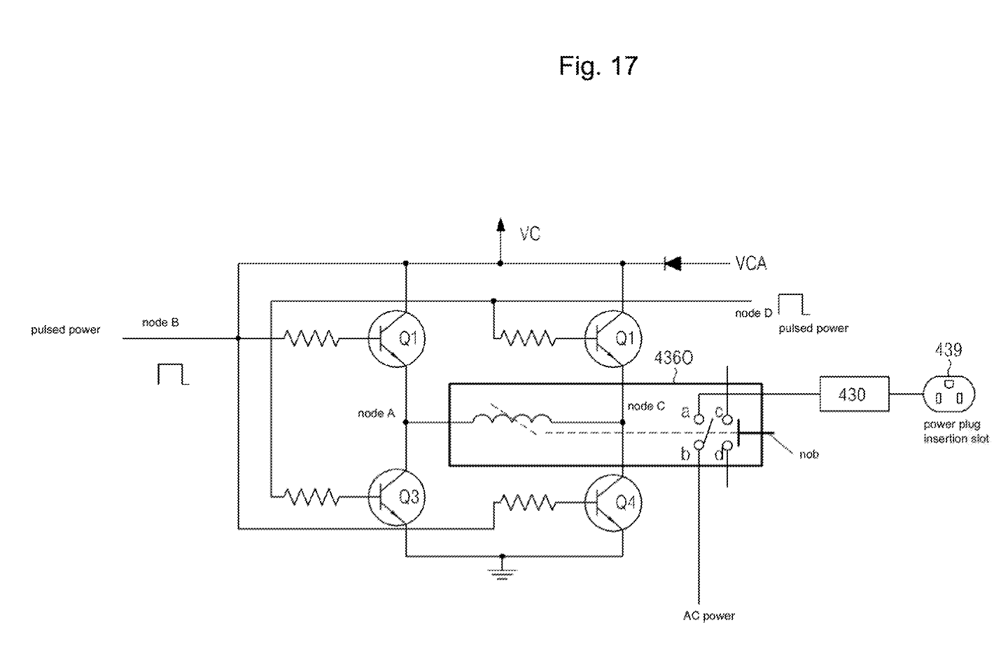

FIG. 17 is a view illustrating an example of an internal major circuit configuration of a manual/remote power supply/cutoff unit that is applicable to a receptacle or a lamp switch according to the second embodiment of the present invention. Referring to FIG. 17, where the device (or lamp) and the receptacle are powered off the manual/remote power supply/cutoff unit 436 or 606 receives pulsed power at a node B which is connected with the central management device via a cable in order to receive a control signal to remotely power on the device (or lamp). The manual/remote power supply/cutoff unit is also configured to receive pulsed power from a node D connected with a microcontroller, which is the controller of the receptacle (or lamp switch), to receive a control signal to power off the device (or lamp) from the microcontroller. Pulsed power from node B or node D is provided to a bridge circuit consisting of switching transistors Q1, Q2, Q3, and Q4 for generating a driving signal to drive the turn-on/off of the manual/remote power supply/cutoff unit 436 or 606 including a solenoid switch structure.

If a voltage is applied by the bridge circuit to the manual/remote power supply/cutoff unit 436 or 606, with node A and node C, respectively, being positive (+) and negative (−), the switching contacts a and b are connected together, so that AC power is supplied to the receptacle or lamp. In contrast, if a voltage is applied, with node A and node C, respectively, being negative (−) and positive (+), the switching contacts a and b are disconnected, cutting off the AC power. If a nob, which is provided to receive manual manipulation from the user, is pressed (by the user), the switching contacts a and b are connected together, enabling AC power to be supplied to the receptacle or lamp. Also in this case, separate switching contacts c and d, which are connected with the nob, are provided to send an on or off signal to the microcontroller configured to connect to the switching contacts c and d.

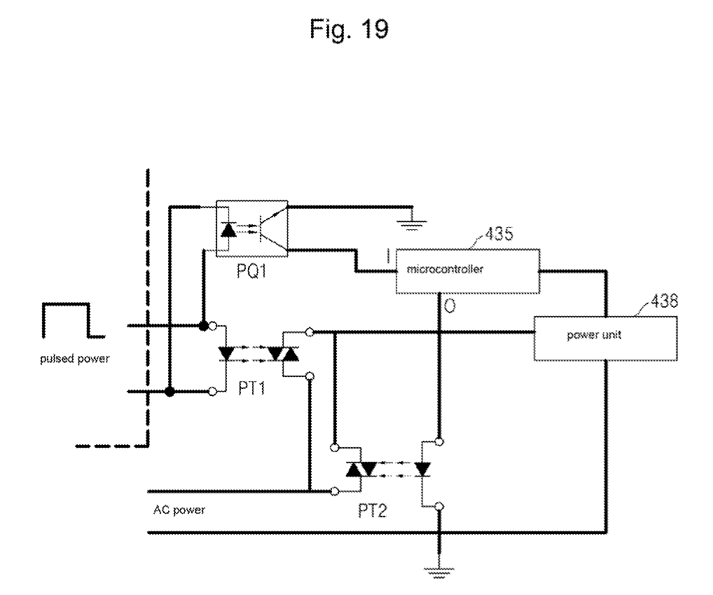

FIG. 19 is a view illustrating another example of an internal major circuit configuration of a manual/remote power supply/cutoff unit that is applicable to a receptacle or a lamp switch according to the second embodiment of the present invention. Unlike the configuration of FIG. 17, the example shown in FIG. 19 has a configuration using, e.g., a photocoupler or phototriac. Referring to FIG. 19, if pulsed power is remotely supplied from a central management device, a LED of a phototriac PT1 is lighted on, and the phototriac PT1 is turned on by light from the LED, allowing AC power to be supplied to a power unit 438 or 608 of a receptacle or lamp switch.

The power unit 438 or 608 supplies power necessary for a microcontroller 435 or 605 so that the microcontroller 435 or 605 outputs power to an output terminal O to light on a LED of a phototriac PT2. The phototriac PT2 is turned on by the light from the LED of the phototriac PT2, allowing the AC power to be continuously supplied to the power unit 438 or 608.

If pulsed power is inputted for remote power-off, a LED of a photocoupler PQ1 is lighted on to turn on a transistor of the photocoupler PQ1, thereby generating an input signal (e.g., a low-level signal) to an input terminal 1 of the microcontroller 435 or 605. If the input signal to the input terminal 1 is generated during the power supplying operation, the microcontroller 435 or 605 determines that it is to cut off the power and stops outputting power to the output terminal O. Resultantly, the phototriac PT2 is turned off, cutting off the supply of AC power.

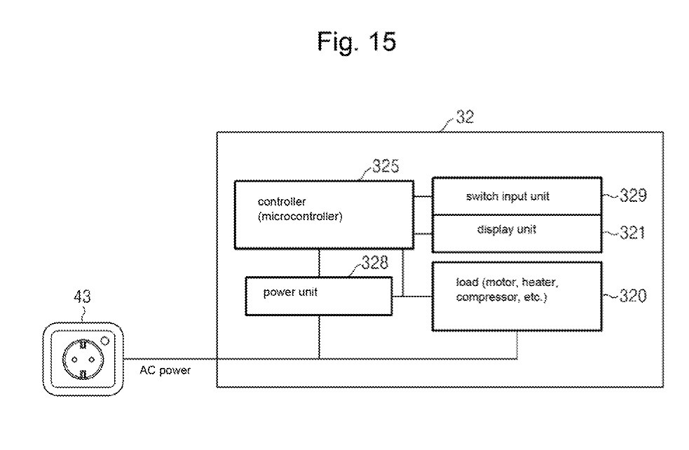

FIG. 15 is a block diagram illustrating a configuration of a normal device to which the second embodiment of the present invention is applicable. Referring to FIG. 15, a normal device 32 may include a load 320, a power unit 328, a display unit 321, a switch input unit 329, and a controller 325. It would be appreciated that an existing normal device can be used as such normal device applicable to the second embodiment of the present invention.

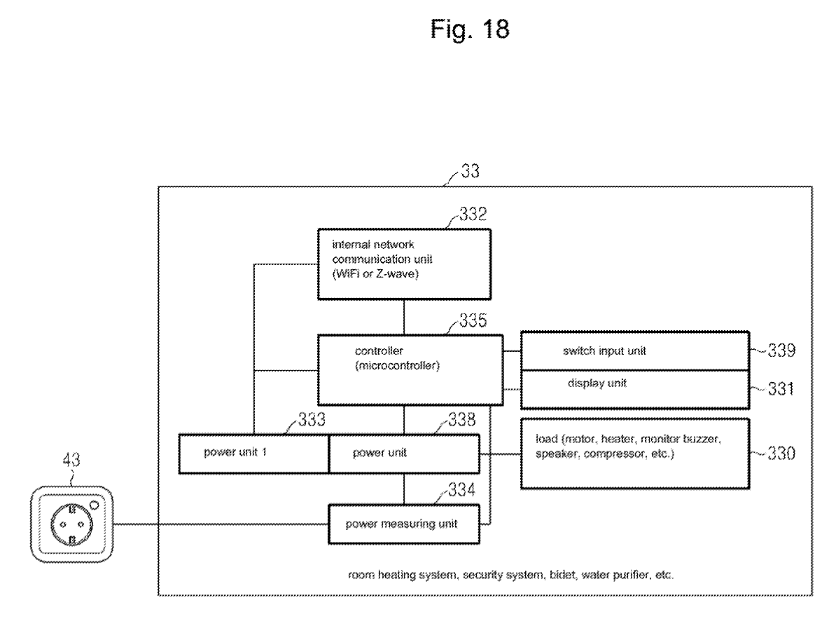

FIG. 18 is a block diagram illustrating a configuration of a first type of device (a device that is not powered off for 24 hours) according to the second embodiment of the present invention. Referring to FIG. 18, a first type of device 33, which is, e.g., a device having Internet-of-Things functionality, includes a power unit 338 that, when power is supplied, generates and supplies power necessary for the device and a sleep mode power unit (power unit 1) 333 that supplies power only to a controller (microcontroller) 335 and an internal network communication unit (Wi-Fi or Z-wave module) 332 to reduce power consumption on standby.

The device 33 may also include a power measuring unit 334, as a means to measure power usage, and a switch input unit 339 and a display unit 331 as input/output devices. Also, the device 33 basically includes (various types of) device loads 330, as means to perform unique functions of the device, depending on the device.

The overall operation of the system according to the second embodiment of the present invention is described below In detail.

[Power supply control] When the central management device 1 supplies pulsed power through cables connected to the receptacle and lamp switch to operate the receptacle 43 and the lamp switch 60, the pulsed power is supplied to, e.g., node B of the receptacle and lamp switch, as shown in FIG. 17. Accordingly, the transistors Q1 and Q4 of the bridge circuit, e.g., as shown in FIG. 17, are turned on to apply a positive (+) voltage and a negative (−) voltage to node A and node C, respectively, of the manual/remote power supply/cutoff unit 4360. Thereafter, a current flows through the solenoid coil, connecting the switching contacts a and b. Thus, AC power is supplied to the receptacle or lamp switch, activating the receptacle and lamp switch.

[Power cutoff control] In the control of cutting off the supply power to the receptacle or lamp switch, the microcontroller of the receptacle and lamp switch supplies pulsed power to node D, turning on the switching transistors Q2 and Q3 of the bridge circuit. Accordingly, a positive (+) voltage and a negative (−) voltage, respectively, are applied to node C and node A of the manual/remote power supply/cutoff unit 4360. Accordingly, a current reversely flows through the solenoid coil, opening the switching contacts a and b. Thus, the AC power provided to the receptacle and lamp switch is cut off. At this time, the self power consumption in the receptacle and lamp switch which has been cut off power supply is zeroed.

[System initialization: ID setting step] If power is supplied while receptacles 43, lamp switches 60, and devices 3 are connected with the central management device 1, the central management device supplies pulsed power to all the receptacles and lamp switches. If power is supplied to the receptacles and lamp switches through such power supply control, the microcontrollers of the receptacles and lamp switches generate their unique IDs, communicate with each other, and identify them so that the IDs do not overlap, thereby setting their IDs. If the ID setting is complete, the microcontrollers store the IDs in their memories (EE-PROM) and notify the central management device to store the IDs in the central management device.

If the same ID is duplicated in several receptacles (or lamp switches) during such operation, the ID setting operation is canceled, and random numbers are randomly computed at time intervals to perform the ID setting operation until their mutual IDs are avoided from overlapping, thereby determining their respective unique IDs.

[System initialization: device-receptacle, lamp-lamp switch matching setting step] If the setting of all the IDs is complete, the central management device requests the receptacle having a first ID in sequence to register the device. At this time, the receptacle supplies power to the device, measures the standby power that flows through the device, computes and determines the standby power value of the device, and stores the standby power value in the memory (EE-PROM). If the standby power value is zero at this time, the receptacle determines that the device is not in connection and notifies the central management device of the presence or absence of the device. The central management device may record the data and identify the presence or absence of the device.

Upon receiving a complete signal from the central management device, the receptacle performs the above-described power cutoff control to cut off the supply of power to the receptacle itself, allowing the power consumption to be zeroed.

The central management device communicates with a next turn of receptacle and repeats the above-described control.

Where the device connected with the receptacle is a device having an Internet-of-Things functionality (refer to FIG. 18), the device is activated immediately when supplied power, enabling communication between the device and the central management device. The central management device notifies the receptacle that the connected device is an IoT device. Thus, without the need for measuring the standby power value, the receptacle stores the type of the matching devie in the memory (EE-PROM), sends a complete signal to the central management device, and upon receiving an acknowledgment complete notification, performs the power cutoff control.

If the receptacle of the ID so registered sequentially finishes the receptacle-device matching, the lamp switch also performs a matching process between the lamp switch and the lamp in the same way as the receptacle.

However, the lamp switch controls the driver, such as supplying power to the lamp, determines that the lamp is connected if a current flows and the lamp is not connected if no current flows, notifies the central management device of the data regarding the presence or absence of the lamp so that the central management device may grasp the data, and sequentially registers and automatically finishes the setting in the same manner as the receptacle.

[System Initialization: device relocation and new registration step] Where the device used to be connected is disconnected, if the current flowing to the device is zeroed due to the disconnection of the device, the receptacle clears the device of the standby power value and notifies the central management device of the data regarding the presence or absence of the device. The central management device stores the removed device and notifies the receptacle. The receptacle, upon receiving an acknowledgment signal, from the central management device, performs the above-described power cutoff control.

Where an additional, device is connected, the receptacle is supplied power and activated by connecting the device to the receptacle and pressing the nob of the receptacle, and the microcontroller of the receptacle recognizes the connection of switching contacts c and d when the nob is pressed and determines that the device has been newly added. When the device is determined to have been newly added, the receptacle controls the device power supply/cutoff unit 430 to supply power to the device, measures and stores the standby power according to the type of the device, and transmits data regarding the presence or absence of the device to the central management device. The central management device recognizes the addition of the device to the receptacle based on the data. If the added device is a device of a type as shown in FIG. 18, the device is activated immediately when supplied power. Thus, the device may communicate with the central management device. Therefore, the central management device notifies the receptacle that the connected device is an IoT device. Without the need for measuring the standby power value, the receptacle stores the type of the matching device in the memory (EE-PROM), sends a complete signal to the central management device, and upon receiving an acknowledgment complete signal, performs the above-described power cutoff control.

[Device control remotely from outside] If the user sends a message to remotely turn on or off a device in the system through the Internet or mobile phone, the central management device verifies, e.g., the ID or password, of a device of control through communication with the outside device, and if verified, sends pulsed power to all the receptacles connected with the device, so that the receptacles are supplied power.

The receptacles wake up, verify whether the ID is theirs, and if inconsistent, immediately perform the above-described power cutoff control to cut off the power to the receptacles. Thus, the self power consumption in the receptacles is zeroed. The receptacle, if the ID is its ID, controls the device power supply/cutoff unit 430 to supply power to the power plug insertion slot 439 so that power can be supplied to the connected device. Thus, the device is activated.

If the device is activated, the receptacle measures and computes the time period of use of device, use time, and power usage of the device, stores data, and sends the data while communicating with the system. At this time, upon receiving a command to remotely turn off the device from the central management device, the receptacle controls the device power supply/cutoff unit 430 to cut off the supply of power to the device, sends data that it stores to the central management device, and if receiving an end acknowledgment notification, performs the above-described power cutoff control. By doing so, the self power consumption in the receptacle becomes zero.

Likewise in the remote lamp control, in the case where the central management device having received a signal for turning on or off the lamp from a remote external device verifies, e.g., the ID or password, through communication with the external device, and if verified, controls the lamp, the central management device sends pulsed power to the lamp switch to supply power to the lamp switch 60. At this time, all the lamp switches wake up, verify whether the ID is theirs, and if inconsistent, immediately perform the above-described lamp light-off control to cut off the power to the lamp switches. Thus, the self power consumption in the lamp switches becomes zero. The lamp switch whose ID is consistent controls the lamp driver to supply power to the connected lamp 70, turning on the lamp. Thereafter, the lamp switch measures and computes the time period of use of the lamp, use time, and power usage of the lamp, stores as data, and sends the relevant data to the system. Upon receiving a command to turn off the lamp from the central management device, the lamp switch controls the lamp driver to cut off the supply of power to the lamp, sends data it stores to the central management device, and upon receiving an end acknowledgment notification from the central management device, performs the above-described power cutoff control. By doing so, the self power consumption in the lamp switch becomes zero.

[Manual device control] A method for manually powering on to use a device is described. Where the device is a device (refer to FIG. 15) free of IoT or communication functionality or a normal device, the switching contacts a and b in the circuit as shown in FIG. 17 are connected by pressing the nob of the manual/remote power supply/cutoff unit 436 of the receptacle 43. Accordingly, the power unit is supplied power, the receptacle is activated, and the switching contacts c and d connected to the microcontroller are connected together. Such is recognized by the microcontroller to be the manual powering-on of the device. Thereafter, the microcontroller controls the device power supply/cutoff unit to supply power to the device connected to the power plug insertion slot, and if the device is used, the microcontroller transmits its device use information (ID and device-related data) data through communication with the central management device to notify of the use of the device.

If the use of the device (refer to FIG. 15) is ended, only standby power is supplied to the device. The receptacle compares the standby power with the standby power value saved for the device, and if the power value is the standby power value, the receptacle determines that the use of the device has been ended. Thereafter, the receptacle transmits data obtained by measuring and computing, e.g., the time period of use of device, use time, and power usage of the device, to the central management device, and upon receiving an end acknowledgment notification from the central management device, performs the above-described power cutoff control.

Where the device is an IoT-capable device (refer to FIG. 18), if the nob of the manual/remote power supply/cutoff unit 436 of the receptacle is pressed, the microcontroller likewise controls the device power supply/cutoff unit to supply power to the device, thereby activating the device. If the device is activated, the receptacle measures and computes the time period of use of device, use time, and power usage of the device, stores data, and sends the data while communicating with the central management device. When the device is manually turned off, the device sends its relevant data (e.g., time period of use, use time, or power usage) and an end signal to the central management device, and upon receiving a reception complete signal from the central management device, the device by itself cuts off the supply of power thereto.

At this time, the receptacle senses the supply of only standby power to the device, determines that the device has been powered off, and transmits an end signal and device-related data recorded in the receptacle to the central management device. The central management device, upon receiving the signal, sends an end acknowledgment signal to the receptacle. The receptacle, upon receiving the end acknowledgment signal from the system, performs the above-described power cutoff control.

[Manual lamp control] If the user presses the nob of the manual/remote power supply/cutoff unit 606 of the lamp switch to turn on the lamp, the microcontroller recognizes that the lamp is manually turned on, controls the lamp driver 600 to supply power to the connected lamp, and if the lamp is turned on, sends its lamp use information (ID and lamp-related data) through communication with the central management device to notify the central management device of the use of lamp.

If the user presses the nob of the manual/remote power supply/cutoff unit 606 of the lamp switch to turn off the lamp, the microcontroller transmits a power-off signa and lamp-related data to the central management device.

The central management device, upon receiving the signal, sends an end acknowledgment signal to the lamp switch. The lamp switch, upon receiving the end acknowledgment signal from the central management device, performs the above-described power cutoff control.

The above-described configuration and control of the system enables efficient energy management.

[Third embodiment] Meanwhile, the configurations according to the first embodiment and the second embodiment of the present invention require separate wiring construction for existing receptacles, raising construction costs.

The third embodiment of the present invention addresses such issue.

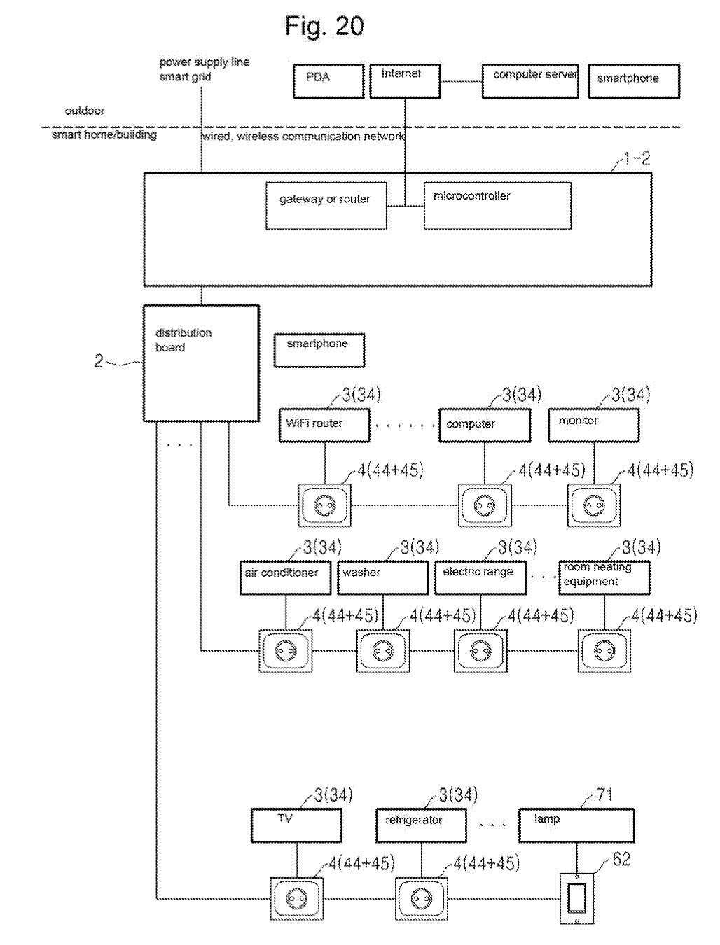

FIG. 20 is a block diagram illustrating a configuration of an energy management system according to the third embodiment of the present invention. Referring to FIG. 20, the energy management system according to the third embodiment of the present invention, similar to the configuration of the second embodiment, includes a central management device 1-2, multiple devices 3, and receptacles 4.

At this time, according to the third embodiment of the present invention, some slave devices (e.g., at least some IoT devices) may have a manual/remote power supply/cutoff unit so that the power plug of the device can be inserted into an existing receptacle and the device can be supplied power or cut off from power supply manually or remotely. The slave devices may also include a current measuring unit for measuring power consumption and an internal network communication unit for enabling wired or wireless communication to communicate integrated power data, device ID, use time, and various data with the central management device.

Meanwhile, in order to control or manage the power of a device without IoT functionality in the third embodiment of the present invention, an adapter-type receptacle may be provided between the device and a legacy receptacle and connected to the legacy device (free of IoT functionality) to analyze and control the use pattern of the legacy device, thereby managing power.

Further, where the device is turned on by an infrared (IR) remote controller while being cut off from power supply, the device includes an IR receiver to receive IR signals.

FIG. 25 is a block diagram illustrating a configuration of a central management device according to the third embodiment of the present invention. Referring to FIG. 25, as compared with the structure according to the second embodiment, the central management device 1-2 according to the third embodiment of the present invention mostly has the same configuration and operation. However, as compared with the structure of the second embodiment, no USB or Ethernet connector is provided, and an IR receiver 109 for receiving signals from an IR remote controller is instead provided to receive remote controller signals.

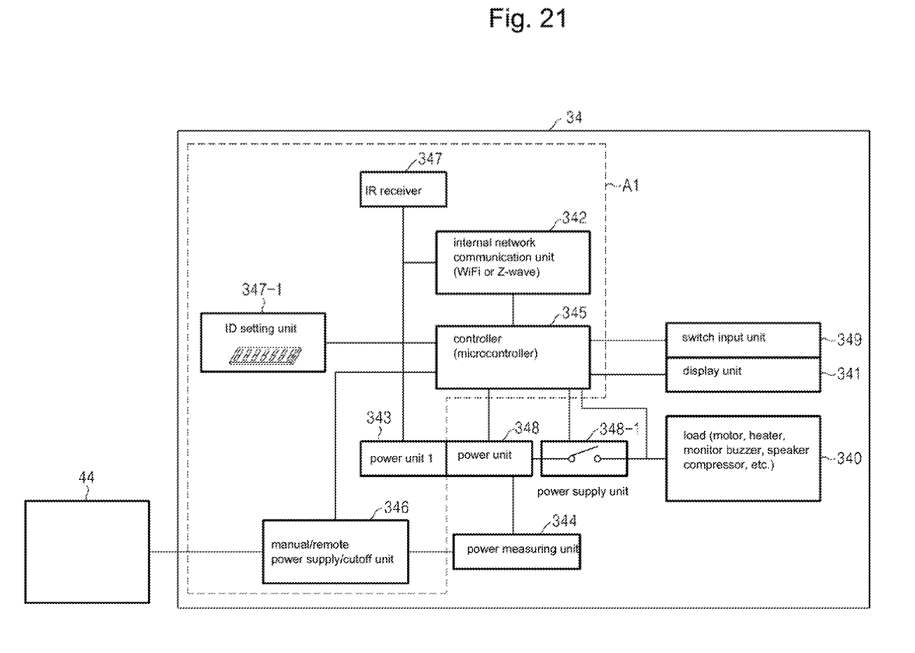

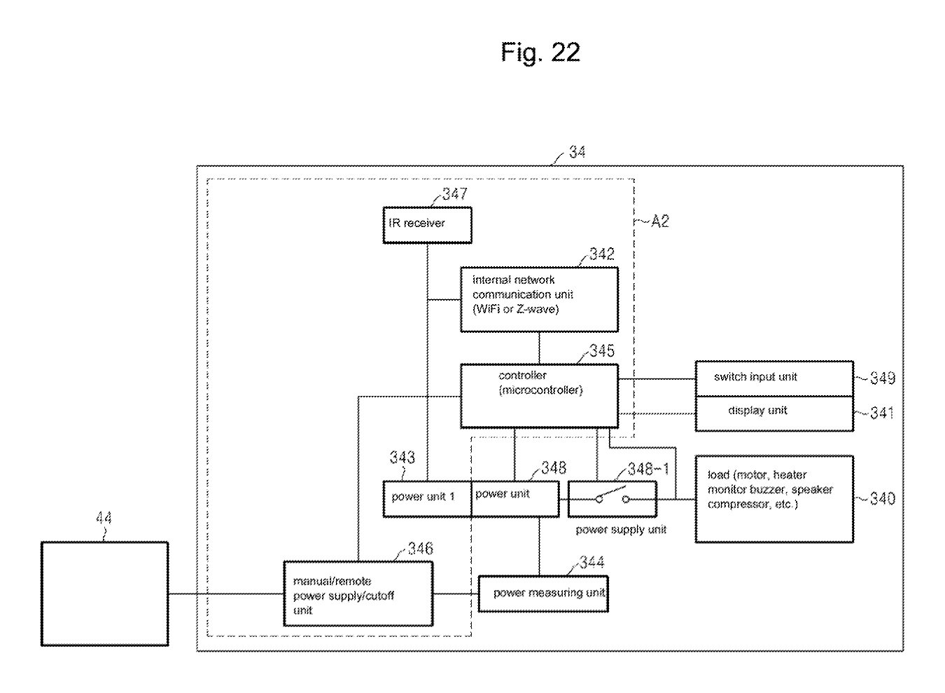

FIG. 21 is a block diagram illustrating a configuration of a first type of IoT device according to the third embodiment of the present invention, and FIG. 22 is a block diagram illustrating a configuration of a second type of IoT device according to the third embodiment of the present invention. Referring to FIGS. 21 and 22, the first-type and second-type devices 34 according to the third embodiment of the present invention are divided depending on ID setting structures. In other words, the devices 34 may be divided into a first type A1 having an ID setting unit 347-1 as a hardware module and a second type A2 having an ID set in an internal memory when manufactured.

Such first-type and second-type devices 34 include a load 340, a manual/remote power supply/cutoff unit 346, a power unit 348, a sleep mode power unit (power unit 1) 343, a power measuring unit 344, an internal network communication unit 342, a controller 345, and a displaying unit 341. The configuration and operation of each function unit may be similar to the configuration and operation of the devices according to other embodiments described above. However, the devices include an IR receiver 347 to receive IR remote controller signals in addition to the components. The sleep mode power unit 343 supplies power only to the IR receiver 347, the controller 347, and the internal network communication unit 342 in a sleep mode.

The configuration shown in FIGS. 21 and 22 enables the power plug of a legacy device to be connected and used for a normal legacy receptacle without changing the legacy receptacle.

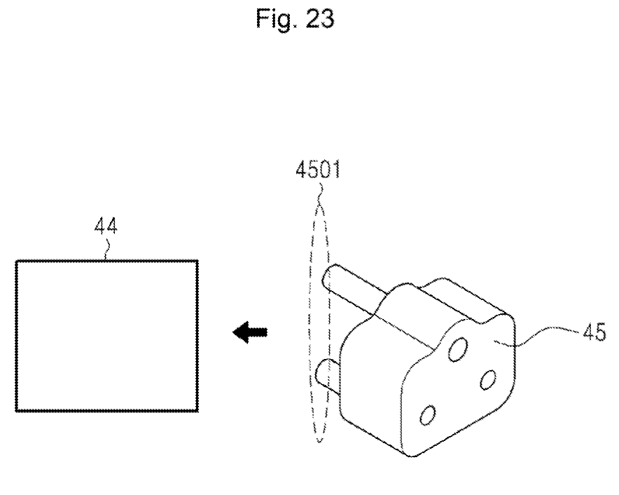

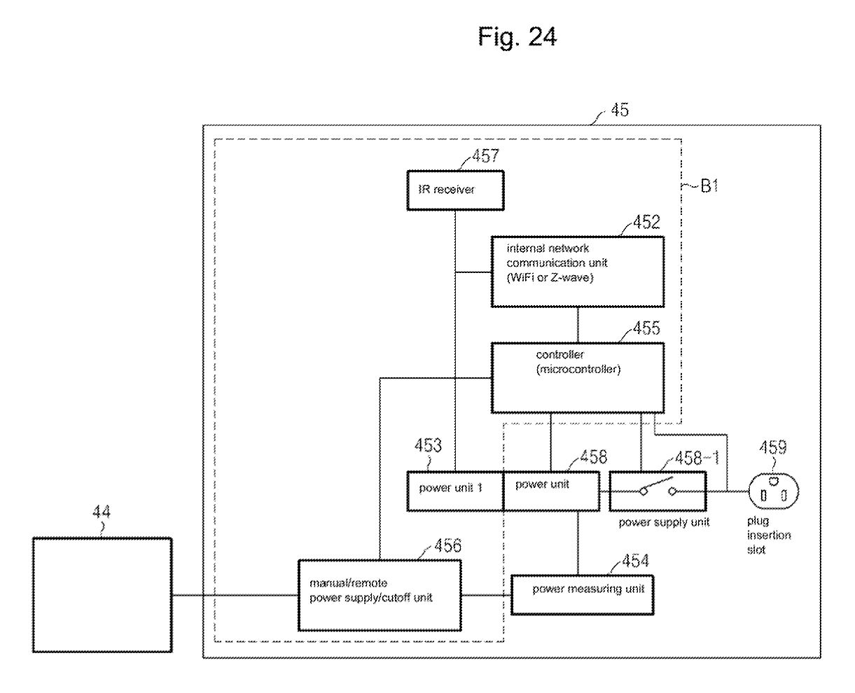

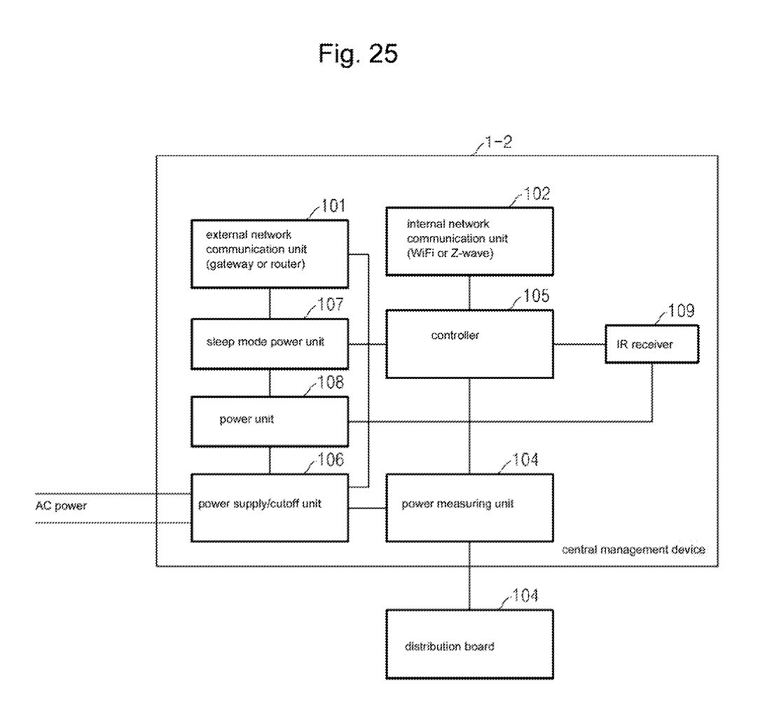

FIG. 23 is a view illustrating an outer shape of a receptacle according to the third embodiment of the present invention, and FIG. 24 is a block diagram illustrating a receptacle according to the third embodiment of the present invention. Referring to FIGS. 23 and 24, the receptacle 45 according to the third embodiment of the present invention has a structure for a connection of a legacy device free of IoT functionality. For example, as shown in FIG. 23, the receptacle 45 has an outer shape like that of an adapter. The receptacle 45 includes a plug insertion slot 459 at a side thereof to allow for insertion of the power plug of a device and a plug 4501 structure at a predetermined position of another side thereof to allow for connection to a legacy receptacle 44. The plug 4501 is connected with an internal manual/remote power supply/cutoff unit 456 of the receptacle 45.

In addition to the plug insertion slot 459 and the manual/remote power supply/cutoff unit 456, the receptacle 45 includes a power supply unit 458-1 to control the supply of power to a device connected to the plug, a power unit 458, a sleep mode power unit (power unit 1) 453, a power measuring unit 454, an internal network communication unit 452, and a controller 455. The configuration and operation of each function unit may be similar to the configuration and operation of a corresponding function unit in, e.g., the receptacle described above in connection with other embodiments. However, the devices include an IR receiver 457 to receive IR remote controller signals in addition to the components. At this time, the IR receiver 457 may be configured to be connected with a connector (not shown) and to be attached at a predetermined external position. The sleep mode power unit 453 supplies power only to the IR receiver 457, the controller 455, and the internal network communication unit 452 in a sleep mode.

When the receptacle 45 is manufactured and shipped out, an ID may be stored in the receptacle. Or, the receptacle 45 may have an ID setting unit (not shown) that enables an ID to be set when the reality service is installed on site.

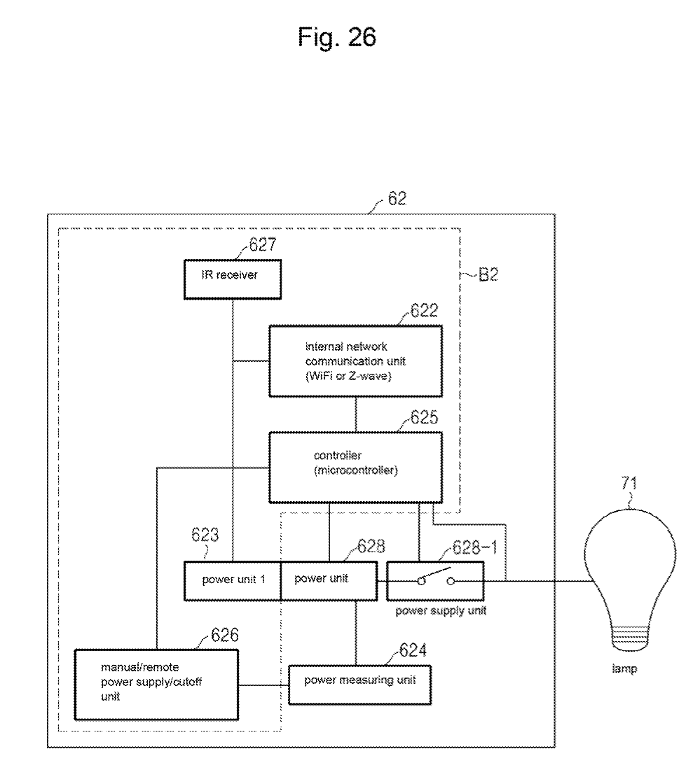

FIG. 26 is a block diagram illustrating a configuration of a lamp switch according to the third embodiment of the present invention. Referring to FIG. 26, the lamp switch 62 according to the third embodiment of the present invention has a configuration for controlling a lamp 71 free of IoT functionality. The lamp switch 62 includes a manual/remote power supply/cutoff unit 626, a power unit 628, a sleep mode power unit (power unit 1) 623, a power measuring unit 624, an internal network communication unit 622, and a controller 625, as well as a power supply unit 628-1 to control the supply of power to the lamp. The configuration and operation of each function unit may be similar to the configuration and operation of a corresponding function unit in, e.g., the lamp switch, described above in connection with other embodiments. However, the devices include an IR receiver 627 to receive IR remote controller signals in addition to the components. At this time, the IR receiver 627 may be configured to be connected with a connector (not shown) and to be attached at a predetermined external position. The sleep mode power unit 623 supplies power only to the IR receiver 627, the controller 625, and the internal network communication unit 622 in a sleep mode.

The overall operation of the system according to the third embodiment of the present invention is described below in detail.

[External remote control] When the central management device 1-2 receives a control signal from an external device, i.e., a smartphone, PDA, wearable device, etc., while being cut off from power supply, the microcontroller, which is the controller of the central management device 1-2, controls the power supply/cutoff unit to supply power to the power unit. Thereafter, the microcontroller performs ID and security check through communication with the external device, and if it is unauthorized information, the microcontroller determines that there is a hacking attempt and controls the power supply/cutoff unit to cut off the power to the power unit while blocking communication. If the information is normal information, the microcontroller transmits the selected ID to a corresponding device 3, a corresponding receptacle 43, or a corresponding straight-line 62.

Upon receiving the ID, the device 3, the receptacle 45, or the lamp switch 62 identifies whether it is its own ID, and its manual/remote power supply/cutoff unit is controlled by the microcontroller to be supplied power and normally operated.

[Data computation, analysis, and user pattern-based control] In order to periodically analyze and manage data collected while the power used to be supplied to the central management device is completely cut off, upon reaching proper times set for periodic management in the central management device, the microcontroller wakes up from the sleep mode, identifies such, and if control is required, supplies power to operate while otherwise turning back to the sleep mode to further save power consumption in the sleep mode.

If the user presses the remote controller to use a device (or a receptacle or lamp switch) through an IR remote controller while the power used to be supplied to the central management device is completely cut off, the IR receiver of the device (or receptacle or lamp switch) receives such a signal. When the signal is received, the microcontroller of the device, receptacle, or lamp switch controls its own manual/remote power supply/cutoff unit to start operation.

At this time, the operated device, receptacle, or lamp switch transmits data (e.g., an ID) being used to the central management device. The central management device verifies the received data, and if verified, sends reception complete signal to the device.

[ID registration control] In configuring the system initialization, if power is supplied, the central management device communicates its ID and initialization data with various devices, receptacles, and lamp switches constituting the system, storing and registering their respective unique IDs.

[Standby power measurement, registration] The receptacle, if its ID Is determined and registered, may supply power to a connected device, measure the standby power of the device, and record the standby power in an internal memory. Likewise, the lamp switch, if its ID is determined and registered, measures the standby power of a lamp connected to the lamp switch and records the standby power in the lamp switch.

[Cutoff of supply of power to device, receptacle, or lamp switch] If an event processing operation is ended, each device automatically transmits relevant data (e.g., a unique ID, power usage, use time, date, or other related information) of the device to the central management device 1, and upon receiving a reception complete signal from the central management device, automatically cuts off the power.

Standby power is generated in each receptacle if the use of the device connected with the receptacle is terminated and is compared with standby power recorded in the receptacle. If they are the same, the power supplied to the device is cut off. Thereafter, the receptacle sends Its relevant data (e.g., a receptacle unique ID, power usage, use time, or date) to the central management device, and upon receiving a data processing complete signal from the central management device, automatically cuts off the power supplied thereto.

Likewise, each lamp switch may also perform the same operation as that of the receptacle.

[Central management device power-off] If all the devices, receptacles, and lamp switches connected to the central management device are cut off from power supply, and all the event processing operations of the central management device are ended, the central management device cuts off its power supply, thereby cutting off the supply of power to the entire system.

The above-described system configuration and operation enable easier installation and complete cutoff of unnecessary power waste without the need for separate construction on a legacy receptacle, leading to efficient energy management.

Although various embodiments of the present invention have been specifically described, the present invention is not limited to the above-described embodiments, and various modifications or changes may be made thereto without departing from the gist of the present invention.

1. An energy management system, comprising:
a central management device; and
a device connected with the central management device through an internal network to transmit information about power usage of the device to the central management device and controlled by the central management device, wherein the device is configured to cut off power supplied thereto in a standby mode and to resume the power supply according to a turn-on signal provided from the central management device.

2. The energy management system of claim 1, wherein the central management device includes an external network communication unit connected to one or more external networks, an internal network communication unit communicating with the internal network, a connector providing a control signal to control supply of power or cutoff of the supply of the power to the device, a power unit receiving external power and converting the external power into operation power for the central management device, a power supply/cutoff unit supplying the external power or cutting off the supply of the external power to the power unit, a sleep mode power unit providing the operation power in the sleep mode, a power measuring unit for measuring self power consumption in the central management device, and a controller controlling the external network communication unit, the internal network communication unit, the connector, the power unit, the power supply/cutoff unit, the sleep mode power unit, and the power measuring unit of the central management device, and wherein the controller controls the power supply/cutoff unit in the standby mode through information provided from the power measuring unit to perform an external power cutoff operation, communicates with an external device and an internal device through the external network communication unit and the internal network communication unit, respectively, and the controller performs control to output the control signal through the connector to the device cut off from power supply.

3. The energy management system of claim 1, further comprising a receptacle connected with the central management device through the internal network and controlled by the central management device, wherein the receptacle includes an internal network communication unit communicating with the internal network, an insertion slot for inserting a power plug of the device, a power measuring unit for measuring power consumption in the device connected through the plug insertion slot, a connector for providing a control signal provided from a connector of the central management device to the device, a power supply/cutoff unit installed on a path along which external power is provided to the insertion slot to conduct or block the path and performing a turn-on operation by the control signal received from the connector of the central management device, a power unit receiving external power from the power supply/cutoff unit and converting the external power into operation power for the receptacle, and a controller controlling the internal network communication unit, the power measuring unit, the connector, the power supply/cutoff unit, and the power unit of the receptacle, and wherein the controller identifies the standby mode of the device through the power measuring unit, controls the power supply/cutoff unit to perform a power cutoff operation, and performs control to provide information obtained by the power measuring unit through the internal network communication unit to the central management device.

4. The energy management system of claim 1, further comprising the a receptacle connected with the central management device through the internal network and controlled by the central management device, wherein the receptacle includes an insertion slot for inserting a power plug of the device and a connector for providing a control signal provided from a connector of the central management device to the device.

5. The energy management system of claim 4, wherein the device includes an internal network communication unit communicating with the internal network, a connector connected with the connector to receive a control signal provided from the connector of the central management device, a power unit connected with the insertion slot of the connector to receive external power and convert the received external power into operation power for the device, a power supply/cutoff unit supplying, or cutting off the supply of, the external power provided to the power unit and performing a turn-on operation by the control signal received from the connector of the central management device, a power measuring unit for measuring self power consumption in the device, and a controller controlling the internal network communication unit, the connector, the power unit, the power supply/cutoff unit, and the power measuring unit of the device, wherein the controller identifies a standby mode through the power measuring unit, controls the power supply/cutoff unit to perform a power cutoff operation, and performs control to provide information obtained by the power measuring unit through the internal network communication unit to the central management device.

6. The energy management system of claim 1, further comprising the a receptacle connected with the central management device through the internal network and controlled by the central management device, wherein the receptacle includes an internal network communication unit communicating with the internal network, an insertion slot for inserting a power plug of the device, a power measuring unit for measuring power consumption in the device connected through the plug insertion slot, a connector receiving a control signal provided from a connector of the central management device, a power supply/cutoff unit installed on a path along which external power is provided to the insertion slot to conduct or block the path and performing a turn-on operation by the control signal received from the connector of the central management device, a power unit receiving external power from the power supply/cutoff unit and converting the external power into operation power for the receptacle, a device power supply/cutoff unit installed on a power path between the power supply/cutoff unit and the insertion slot to block or conduct the power supply path under the control of a controller, and the controller overall controlling the internal network communication unit, the power measuring unit, the connector, the power supply/cutoff unit, and the power unit, and the device power supply/cutoff unit of the receptacle, and wherein the controller identifies the standby mode of the device through the power measuring unit, controls the power supply/cutoff unit to perform a power cutoff operation, and performs control to provide information obtained by the power measuring unit through the internal network communication unit to the central management device.

7. The energy management system of claim 1, further comprising a lamp switch connected with the central management device through the internal network to transmit information about power usage of the lamp switch to the central management device, the lamp switch controlled for operation by the central management device, wherein the lamp switch is configured to cut off power supplied thereto in the standby mode and to resume the power supply according to a turn-on signal provided from the central management device when the power is cut off.

8. The energy management system of claim 7, wherein the lamp switch includes an internal network communication unit communicating with the internal network, a power measuring unit for measuring power consumption in a lamp connected with the lamp switch, a connector receiving a control signal provided from a connector of the central management device, a power supply/cutoff unit installed on a path along which external power is provided to conduct or block the path and performing a turn-on operation by the control signal received from the connector of the central management device, a power unit receiving external power from the power supply/cutoff unit and converting the external power into operation power for the lamp switch, a lamp driver installed on a power path between the power supply/cutoff unit and the connected lamp to block or conduct the power supply path under the control of a controller, and the controller controlling the internal network communication unit, the power measuring unit, the connector, the power supply/cutoff unit, the power unit, and the lamp driver of the lamp switch, and wherein the controller performs control to provide information obtained by the power measuring unit through the internal network communication unit to the central management device.

9. The energy management system of claim 1, wherein the central management device includes an external network communication unit connecting to one or more external networks, an internal network communication unit communicating with the internal network, an infrared (IR) receiver for receiving a signal from an external infrared remote controller, a power unit receiving external power and converting the external power into operation power for the central management device, a power supply/cutoff unit supplying the external power or cutting off the supply of the external power to the power unit, a sleep mode power unit providing the operation power in the sleep mode, a power measuring unit for measuring self power consumption in the central management device, and a controller controlling the external network communication unit, the internal network communication unit, the IR receiver, the power unit, the power supply/cutoff unit, the sleep mode power unit, and the power measuring unit of the central management device, and wherein the controller controls the power supply/cutoff unit in the standby mode through information provided from the power measuring unit to perform an external power cutoff operation and performs control to communicate with an external device and an internal device through the external network communication unit and the internal network communication unit, respectively.

10. The energy management system of claim 1, wherein the device includes an internal network communication unit communicating with the internal network, an IR receiver for receiving a signal from an external infrared remote controller, a power unit receiving external power and convert the external power into operation power for the device, a power supply/cutoff unit supplying, or cutting off the supply of, the external power provided to the power unit, a power measuring unit for measuring self power consumption in the device, a sleep mode power unit providing the operation power in the sleep mode and a controller controlling the internal network communication unit, the IR receiver, the power unit, the power supply/cutoff unit, the power measuring unit, and the sleep mode power unit of the device, wherein the controller identifies the standby mode through the power measuring unit, controls the power supply/cutoff unit to perform a power cutoff operation, and performs control to provide information obtained by the power measuring unit through the internal network communication unit to the central management device.

11. The energy management system of claim 1, further comprising the a receptacle connected with the central management device through the internal network and controlled by the central management device, wherein the receptacle includes an internal network communication unit communicating with the internal network, an insertion slot for inserting a power plug of the device, a power measuring unit for measuring power consumption in the device connected through the plug insertion slot, an IR receiver for receiving a signal from an external infrared remote controller, a power supply/cutoff unit installed on a path along which external power is provided to the insertion slot to conduct or block the path, a power unit receiving external power from the power supply/cutoff unit and converting the external power into operation power for the receptacle, a sleep mode power unit providing the operation power in the sleep mode a device power supply/cutoff unit installed on a power path between the power supply/cutoff unit and the insertion slot to block or conduct the power supply path under the control of a controller, and the controller controlling the internal network communication unit, the power measuring unit, the IR receiver, the power supply/cutoff unit, the power unit, the sleep mode power unit, and the device power supply/cutoff unit of the receptacle, and wherein the controller identifies the standby mode of the connected device through the power measuring unit, controls the power supply/cutoff unit to perform a power cutoff operation, and performs control to provide information obtained by the power measuring unit through the internal network communication unit to the central management device.

12. The energy management system of claim 7, wherein the lamp switch includes an internal network communication unit communicating with the internal network, a power measuring unit for measuring power consumption in a lamp connected with the lamp switch, an IR receiver for receiving a signal from an external infrared remote controller, a power supply/cutoff unit installed on a path along which external power is provided to conduct or block the path, a power unit receiving external power from the power supply/cutoff unit and converting the external power into operation power for the lamp switch, a sleep mode power unit providing the operation power in the sleep mode, a lamp driver installed on a power path between the power supply/cutoff unit and the connected lamp to block or conduct the power supply path under the control of a controller, and the controller controlling the internal network communication unit, the power measuring unit, the IR receiver, the power supply/cutoff unit, the power unit, the sleep mode power unit, and the lamp driver of the lamp switch, and wherein the controller performs control to provide information obtained by the power measuring unit through the internal network communication unit to the central management device.
